(19) United States
(12) Patent Application Publication
(10) Pub. No.: US 2021/0352855 A1
(43) Pub. Date: Nov. 18, 2021

(54) CROP NETTING MATERIAL

(71) Applicant: Nine IP Limited, Auckland (NZ)

(72) Inventor: Jonathan Dallas TOYE, Auckland (NZ)

(21) Appl. No.: 17/216,530

(22) Filed: Mar. 29, 2021

Related U.S. Application Data
(62) Division of application No. 15/765,355, filed on Apr. 2, 2018, now abandoned.

(30) Foreign Application Priority Data
Oct. 22, 2015 (NZ) 713548
Feb. 26, 2016 (NZ) 717496

(51) Int. Cl. A01G 13/10; A01G 9/14; A01G 13/02; D03D 1/00; D03D 9/00; D03D 19/00; D04B 21/10

(52) U.S. Cl. CPC A01G 13/10; A01G 9/1438; A01G 13/0206; D03D 1/0035; A01G 2009/1461; D03D 19/00; D04B 21/10; Y02A 40/25; A01G 2009/1446; D03D 9/00

(57) ABSTRACT

Described herein is a pillar knitted crop netting comprising widely spaced knitted pillars and crop netting materials comprising a region(s) having such construction. Also described herein are crop nettings comprising yarns defining apertures to form the netting wherein said apertures have a plurality of sides formed by yarn sections and at least one of those yarn sections may be relatively slack when the netting is held taut in lengthwise and widthwise directions. The above nettings may have advantageous hail passage performance.

### FIELD OF THE INVENTION

This invention relates to agricultural materials, particularly but not exclusively to knitted crop production enhancement (including crop protection) materials, such as those that protect against damage caused by wind, sun, hail, rain, birds or insects, or in other agricultural applications such as modifying a plant's environment, for example modifying temperature or solar radiation characteristics of a plant's environment.

### RELATED APPLICATIONS

This application derives priority from New Zealand provisional patent application numbers 713548, filed 22 Oct. 2015 and 717496, filed 26 Feb. 2016, the contents of both of which are incorporated herein by reference.

### BACKGROUND

Knitted, woven or non-woven crop materials may be used in agriculture to shelter crops or animals from exposure to adverse environmental conditions, such as wind, sun, hail or rain, or to provide protection from animals, such as birds or insects, that may damage a crop. They may also be used to modify a plant's environment, such as modifying temperature or solar radiation characteristics of a plant's environment.

When such materials are knitted materials, they may be knitted in any one of a variety of knit patterns or structures. Common knit patterns include those where the basic knit structure forms diamond shaped apertures, hexagonal shaped apertures, square or rectangular shaped apertures, or where the basic structure comprises knitted pillars joined by crossover yarns.

When such materials are woven materials, they may be woven in any one of a variety of weave patterns, for example plain weave or leno weave.

A material having a knitted pillar construction, hereinafter ‘pillar knitted fabric’, is a knitted material comprising pillars of knitted yarn with the pillars in generally parallel arrangement and held together by crossover yarns that cross back and forth along the length of the pillars between each pillar and an adjacent pillar. Such materials are typically knitted on a warp knitting machine.

Pillar knitted fabrics are often used in installations of crop material where the material is suspended by a support structure above a crop, or a row of plants. A particular advantage of such a material is that the pillars stabilise the material in the direction of the length of pillar meaning that the material has very limited stretch along the length of the pillar. The crossover yarns knitted into the pillar also provide limited stretch across the width of the material.

Pillar knitted fabrics may be knitted on a warp knitting machine. Speed of production is limited by the distance between adjacent pillars and the frequency in which the crossover yarns cross back and forth along the length of the pillar. The wider the spacing between pillars, the further each needle has to travel back and forth across the fabric and the slower the fabric is to produce. More specifically, for example, looking at a single loom needle knitting a single crossover yarn, that needle will travel back and forth across and along the space between two pillars. The rate of progression along the length of the fabric (relatively speaking) of that needle limits the rate of production of the material. If the distance between pillars is halved, each needle only has to travel back and forth across the half the distance, thereby enabling a quicker rate of progression along the length of the material and increasing production speed. Because of this, crop protection materials in the form of pillar knitted fabrics have a pillar spacing of no greater than 12 mm. The frequency of crossovers also impacts upon production speed, with greater crossover frequency resulting in slower production.

Crop netting for the purpose of protecting crops from hail damage is available in a variety of knit structures, including knit structures having diamond shaped apertures, hexagonal shaped apertures, square or rectangular shaped apertures, or pillar knit structures. Hail nettings protect crops by providing a physical barrier above a plant to shield it from hail fall. A disadvantage of hail nettings is that a large hail fall may collect on the upper side of the hail netting and, due to the weight of accumulated hail, cause the netting to tear or the structure supporting the netting to collapse.

In some installations of hail netting, the netting is installed at an angle or angles, such that hailstones landing on the netting may roll across and be released through specially constructed zones for passage of hail stones. Such installations may lack simplicity and be expensive.

Bees are important to assist in pollination of many crop plants. Bee hives may be placed inside a netted block to be used in conjunction with netting installations to assist with pollination of plants.

It is an object of the present invention to provide an improved crop netting, or at least to provide the public with a useful choice.

Further aspects and advantages of the invention will become apparent from the following description that is given by way of example only.

### SUMMARY OF THE INVENTION

Described herein is a pillar knitted fabric comprising a first region having widely spaced knitted pillars. Further described herein is a crop netting having crossover yarns comprising sections of different length along the crossover yarns between two adjacent pillars. Still further described herein is a crop netting with lay-ins that may move to allow hail passage through a netting.

1. In a first aspect the invention provides a crop netting comprising a first region comprising a plurality of pillars of spaced apart yarn extending in a first direction, each pillar formed from at least one pillar yarn optionally comprising a plurality of knots along its length,
and a plurality of crossover yarns extending across or between the pillars,
each crossover yarn comprising a plurality of crossover sections, said crossover sections defined by the portions of the crossover yarn traversing the space between adjacent pillars,
wherein at least some crossover sections between pillars have a different length than at least some other crossover sections between the same pillars, and/or
wherein the tightness of the knots along a length of a pillar yarn varies along the length of the pillars,
for at least a majority of the area of the first region.

2. In some embodiments the first region is knitted.

3. In some embodiments the first region is woven, or non-woven.

4. In some embodiments at least 20%, or 30%, or 40%, or 50%, or 60%, or 70%, or 80% of the crossover sections between pillars are at least 0.05 mm, or 0.08 mm or 0.1 mm, or 0.2 mm, or 0.3 mm, or 0.4 mm, or 0.5 mm, 0.6 mm, or 0.7 mm, or 0.8 mm, or 0.9 mm, 1.0 mm, or 1.1 mm, or 1.2 mm, or 1.4 mm, or 1.6 mm or 1.8 mm, or 2.0 mm, or 2.2 mm, or 3.0 mm, or 4.0 mm longer than the remainder of the crossover sections between the same two pillars.

5. In a second aspect the invention provides a crop netting comprising a first region comprising
pillars of knitted yarn
held together to form a sheet material
by crossover yarns that traverse or cross back and forth between adjacent pillars along a length of the netting, and defining apertures in the netting,
each crossover yarn comprising a plurality of crossover sections, said crossover sections defined by portions of the crossover yarn between pillars and immediately adjacent pillars, and wherein, for at least a majority of the area of the first region, either:
(i) a difference in length between at least some crossover sections and at least some other crossover sections is greater than 0.05 mm; and/or
(ii) a difference in length between at least some crossover sections and a next crossover section along the same crossover yarn is greater than 0.05 mm ; and/or
(iii) a longest 50% of crossover sections between at least two immediately adjacent pillars are at least 0.05 mm longer than a shortest 50% of crossover sections between the same two immediately adjacent pillars; and/or
(iv) a longest 30% of crossover sections between at least two immediately adjacent pillars are at least 0.05 mm longer than a shortest 30% of crossover sections between the same two immediately adjacent pillars; and/or
(v) at least some crossover sections knitted in one direction are longer than the at least some crossover sections of the crossover yarns knitted in an opposite direction; and/or
(vi) at least some crossover sections are shorter than other crossover sections and said shorter crossover sections are spaced along a length of the netting such that when the netting is installed under tension said shorter crossover yarns can bear said tension while longer crossover sections are under less or no tension and have a greater freedom of movement, said tension being applied generally perpendicularly to the length of the pillars and in the plane of the netting; and/or
(vii) each crossover section has a length defined by a distance measured along said crossover in the space defined between adjacent pillars and wherein each crossover section has a midpoint halfway along said length and wherein said midpoint may move with a range of at least 1.8 mm when said first region is held taut, but not stretched, in said first direction and in a direction orthogonal to said first direction, when said midpoint is placed under a force back and forth along an axis aligned with said first direction; and/or
(vii) each crossover section has a length defined by a distance measured along said crossover in the space defined between adjacent pillars and wherein each crossover section has a midpoint halfway along said length and wherein said midpoint may move with a range of at least 0.18 mm per mm for every mm of crossover length when said first region is held taut, but not stretched, in said first direction and in a direction orthogonal to said first direction, when said midpoint is placed under a force back and forth along an axis aligned with said first direction.

6. In some embodiments the first region comprises either:
(i) a difference in length between at least some crossover sections and at least some other crossover sections is greater than 0.08 mm or 0.1 mm, or 0.2 mm, or 0.3 mm, or 0.4 mm, or 0.5 mm, 0.6 mm, or 0.7 mm, or 0.8 mm, or 0.9 mm, 1.0 mm, or 1.1 mm, or 1.2 mm, or 1.4 mm, or 1.6 mm or 1.8 mm, or 2.0 mm, or 2.2 mm, or 3.0 mm, or 4.0 mm; and/or
(ii) a difference in length between at least some crossover sections and a next crossover section along the same crossover yarn is greater than 0.08 mm or 0.1 mm, or 0.2 mm, or 0.3 mm, or 0.4 mm, or 0.5 mm, 0.6 mm, or 0.7 mm, or 0.8 mm, or 0.9 mm, 1.0 mm, or 1.1 mm, or 1.2 mm, or 1.4 mm, or 1.6 mm or 1.8 mm, or 2.0 mm, or 2.2 mm, or 3.0 mm, or 4.0 mm, longer than the shortest 50% of crossover sections of each crossover yarn; and/or
(iii) a longest 50% of crossover sections between at least two immediately adjacent pillars are at least 0.08 mm or 0.1 mm, or 0.2 mm, or 0.3 mm, or 0.4 mm, or 0.5 mm, 0.6 mm, or 0.7 mm, or 0.8 mm, or 0.9 mm, 1.0 mm, or 1.1 mm, or 1.2 mm, or 1.4 mm, or 1.6 mm or 1.8 mm, or 2.0 mm, or 2.2 mm, or 3.0 mm, or 4.0 mm, longer than a shortest 50% of crossover sections between the same two immediately adjacent pillars; and/or
(iv) a longest 30% of crossover sections between at least two immediately adjacent pillars are at least 0.08 mm or 0.1 mm, or 0.2 mm, or 0.3 mm, or 0.4 mm, or 0.5 mm, 0.6 mm, or 0.7 mm, or 0.8 mm, or 0.9 mm, 1.0 mm, or 1.1 mm, or 1.2 mm, or 1.4 mm, or 1.6 mm or 1.8 mm, or 2.0 mm, or 2.2 mm, or 3.0 mm, or 4.0 mm longer than a shortest 30% of crossover sections between the same two immediately adjacent pillars; and/or
(v) at least some crossover sections of each crossover yarn knitted in one direction are at least 0.08 mm or 0.1 mm, or 0.2 mm, or 0.3 mm, or 0.4 mm, or 0.5 mm, 0.6 mm, or 0.7 mm, or 0.8 mm, or 0.9 mm, 1.0 mm, or 1.1 mm, or 1.2 mm, or 1.4 mm, or 1.6 mm or 1.8 mm, or 2.0 mm, or 2.2 mm, or 3.0 mm, or 4.0 mm longer than at least some crossover sections knitted in the opposite direction; and/or
(vi) each crossover section has a length defined by a distance measured along said crossover in the space defined between adjacent pillars and wherein each crossover section has a midpoint halfway along said length and wherein said midpoint may move with a range of at least 2.0 mm, or at least 2.5 mm, or at least 3.0 mm, or at least 3.5 mm, or at least 4.0 mm, or at least 4.5 mm, or at least 5.0 mm, or at least 6 mm, or at least 7 mm, or at least 8 mm, or at least 9 mm, when said first region is held taut, but not stretched, in said first direction and in a direction orthogonal to said first direction, when said midpoint is placed under a force back and forth along an axis aligned with said first direction, and/or
(vii) each crossover section has a length defined by a distance measured along said crossover in the space defined between adjacent pillars and wherein each crossover section has a midpoint halfway along said length and wherein said midpoint may move with a range of at least 0.19 mm, or at least 0.20 mm, or at least 0.22 mm, or at least 0.23 mm, or at least 0.24 mm, or at least 0.25 mm, or at least 0.27 mm, or at least 0.3 mm or at least 0.35 mm, or at least 0.4 mm, or at least 0.5 mm, or at least 0.6 mm, for every mm of crossover length when said first region is held taut, but not stretched, in said first direction and in a direction orthogonal to said first direction, when said midpoint is placed under a force back and forth along an axis aligned with said first direction.

7. In some embodiments the crossover distance (as defined herein) is between 2 and 12 mm, 2 and 10 mm, 2 and 8 mm, 3 and 6 mm, or about 5 mm.

8. In some embodiments the crossover sections are arranged in repeating pairs of one shorter and one longer, said repeating pairs repeating along the length of the space between two adjacent pillars.

9. In some embodiments the crossover sections between pillars are arranged in groups of one, two, three, four or more shorter crossover sections interspersed among groups of one, two, three, four or more longer crossover sections.

10. In a third aspect the invention provides a crop netting comprising a first region comprising
pillars of knitted yarn
held together to form a sheet material
by crossover yarns that traverse or cross back and forth along the length of the netting between pillars and adjacent pillars, and define apertures in the netting,
wherein the pillars are spaced apart from each other by at least 13 mm.

11. In a fourth aspect the invention provides a crop netting comprising a first region comprising
pillars of knitted yarn
held together to form a sheet material
by crossover yarns that traverse or cross back and forth along the length of the netting between pillars and adjacent pillars, and define apertures in the netting,
wherein the pillars are spaced apart from each other by at least 13 mm, and wherein the apertures have an aperture size of less than 6 mm.

12. In some embodiments the crop netting is longer than it is wide and the pillars extend in the lengthwise direction.

13. In some embodiments the pillars are separated by a pillar distance of greater than about 13 mm, or greater than about 14 mm, or greater than about 15 mm, or greater than about 16 mm, or greater than about 17 mm, or greater than about 18 mm, or greater than about 19 mm, or greater than about 20 mm, or greater than about 22 mm, or greater than about 24 mm, or greater than about 26 mm, or greater than about 28 mm, or a separated by a pillar distance of between about 3 mm and about 48 mm, or between about 13 mm and about 48 mm, or between about 14 mm and about 48 mm, or between about 16 mm and about 48 mm, or between about 18 mm and about 48 mm, or between about 20 mm and about 48 mm, or between about 22 mm and about 48 mm, or a separated by a pillar distance of between about 3 mm and about 56 mm, or between about 13 mm and about 56 mm, or between about 14 mm and about 56 mm, or between about 16 mm and about 56 mm, or between about 18 mm and about 56 mm, or between about 20 mm and about 56 mm, or between about 22 mm and about 56 mm, or a separated by a pillar distance of between about 3 mm and about 64 mm, or between about 13 mm and about 64 mm, or between about 14 mm and about 64 mm, or between about 16 mm and about 64 mm, or between about 18 mm and about 64 mm, or between about 20 mm and about 64 mm, or between about 22 mm and about 64 mm, or between about 6 mm and about 44 mm, or between about 8 mm and about 42 mm, or between about 10 mm and about 40 mm, or between about 14 mm and about 40 mm, or between about 14 mm and about 38 mm, or between about 16 mm and about 34 mm, or between about 16 mm and 35 mm, or between about 16 mm and about 30 mm, or between about 18 mm and about 32 mm, or between about 20 mm and about 28 mm, or between about 16 mm and 28 mm, or between about 18 mm and about 26 mm, or between about 20 mm to 26 mm, or between about 22 mm and about 26 mm or about 24 mm, or within a range of 24 mm+/−6 mm, or within a range of 28 mm+/−6 mm, or within a range of 32 mm+/−6 mm, or within a range of 36+/−6 mm, or within a range of 48 mm+/−6 mm, or within a range of 56 mm+/−6 mm, or within a range of 64 mm+/−6 mm.

14. In some embodiments the aperture size is less than 8 mm, or less than 7 mm, or less than 6 mm, or less than 5 mm, or less than 4 mm, or less than 3 mm, or less than 2 mm.

15. In some embodiments the crossover distance (as defined herein) is between 2 and 12 mm, 2 and 10 mm, 2 and 8 mm, 3 and 6 mm, or about 5 mm.

16. In some embodiments the crossover yarns comprise a rubber modifier.

17. In some embodiments the apertures are generally triangular, including acute triangular, right angle triangular or oblique triangular, or three-sided in shape.

18. In some embodiments the apertures are generally square in shape.

19. In a fifth aspect the invention provides a crop netting having a length dimension and a width dimension, wherein in at least a first region of said netting comprises yarns defining apertures to form said first region, each of said apertures comprising a plurality of sides, each side formed by a yarn section extending across said length dimension or said width dimension, each yarn section having a length and midpoint thereof halfway along said length, wherein at least 25% of said apertures comprise either:
a first yarn section and a second yarn section both extending across said width dimension, wherein the midpoint of the first yarn section can move a greater distance in a direction orthogonal to said first yarn section than a midpoint of the second yarn section of the same aperture in a direction orthogonal to said second yarn section when each of said midpoints of said yarn sections are placed under the same amount of force back and forth along an axis orthogonal to each of said yarn sections and in the plane of the netting, when said crop netting is held taut, but not stretched, in said width dimension, and/or
a first yarn section and a second yarn section both extending across said length dimension, wherein the midpoint of the first yarn section can move a greater distance in a direction orthogonal to said first yarn section than a midpoint of the second yarn section of the same aperture in a direction orthogonal to said second yarn section when each of said midpoints of said yarn sections are placed under the same amount of force back and forth along an axis orthogonal to each of said yarn sections and in the plane of the netting, when said crop netting is held taut, but not stretched, in said length dimension.

20. In some embodiments the movement is measured from the natural lie position of the first yarn section and in a direction outward from said aperture along said orthogonal axes, said force being applied in a direction outward from said aperture along said orthogonal axes.

21. In some embodiments the netting is of pillar knitted construction and said first and second yarn sections comprise crossovers forming two sides of a triangular aperture.

22. In some embodiments the netting is square, rectangular or diamond shaped aperture construction.

23. In some embodiments the first and second yarn sections form opposing sides of the apertures of said square, rectangular or diamond shaped construction.

24. In some embodiments the distance that the first yarn section may move is 0.2 mm, or more than 0.3 mm, or more than 0.4 mm, or more than0.6 mm, or more than 0.8 mm, or more than 1.0 mm, or more than 1.25 mm, or more than 1.5 mm, or more than 1.75 mm, or more than 2.0 mm or more than 2.5 mm, or more than 3.0 mm, or more than 3.5 mm, or more than 4.0 mm, or more than 5 mm, or more than 6 mm, or more than 7 mm, or more than 8 mm, greater than this distance that the second yarn section may move.

25. In some embodiments the netting is formed from yarns having a denier of between 100 and 3500, or 100 and 2500, or 100 and 2000, and 100 and 1500, or 100 and 1000, or 150 and 800, or 200 and 700, or 200 and 600, or 200 and 300, or 450 and 550, or about 250, or about 500.

26. In some embodiments the netting has a mass of between 20 and 400 gsm, or 40 and 350 gsm, or 40 and 300 gsm, or 40 and 250 gsm, or 40 and 200 gsm, or 60 and 180 gsm, or 80 and 140 gsm.

27. In some embodiments the netting has a length greater than its width and a width of at least 0.5 m, or at least 1.0 m, or at least 1.5 m, or at least 2.0 m, or at least 2.5 m, or at least 3.0 m, or at least 3.5 m, or at least 4.0 m, or at least 4.5 m, or at least 5 m, or at least 6 m, or at least 7 m, or at least 8 m, or at least 9 m, or at least 10 m, or at least 12 m, or at least 14 m, or at least 16 m, or at least 18 m, or at least 20 m, or at least 25 m, or at least 30 m.

28. In some embodiments the netting has a length at least 10, or at least 20, or at least 30, or at least 40, or at least 50, or at least 75, or at least 100, or at least 125, or at least 150, or at least 175, or at least 200, or at least 250, or at least 300, or at least 400 or at least 600 times its width.

29. In some embodiments the netting has a cover factor (as herein defined) of less than 30%, less than 20%, less than 10%, or less than 5%.

30. In some embodiments the first region is a main body region.

31. In some embodiments the first region comprises more than about 30%, or more than about 40%, or more than about 50%, or more than about 60%, or more than about 70%, or more than about 80%, or more than about 90% of the of the crop netting, or comprises all of the crop netting.

32. In some embodiments the crop netting is longer than it is wide and wherein main body region comprises more than about 30%, or more than about 40%, or more than about 50%, or more than about 60%, or more than about 70%, or more than about 80%, or more than about 90%, of the of the width of the crop netting.

33. In some embodiments the first region comprises less than about 50% of the crop netting, or less than about 40% of the crop netting, or less than about 30% of the crop netting, or less than about 20% of the crop netting, or less than about 10%, of the crop netting.

34. In some embodiments the crop netting is longer than it is wide and the first region comprises less than about 50%, or less than about 40%, or less than about 30%, or less than about 20%, or less than about 10%, of the width of the crop netting.

35. In some embodiments the crop netting is longer than it is wide and the first region comprises a band or bands extending lengthwise along, or substantially the length of, the crop netting.

36. In some embodiments the bands have a width of between 4 cm and 2.0 m, or between 8 cm and 2.0 m, or between 10 cm and 2.0 m, or between 15 cm and 2.0 m, or between 20 cm and 2.0 m, or between 40 cm and 2.0 m, or between 4 cm and 1.0 m, or between 8 cm and 1.0 m, or between 10 cm and 1.0 m, or between 15 cm and 1.0 m, or between 20 cm and 1.0 m, or between 40 cm and 1.0 m, or between 4 cm and 0.5 m or between 0.5 m to 1.0 m, or between 1.0 m and 1.5 m, or between 1.5 m to 2.0 m.

37. In some embodiments the bands are separated by at least 0.5 m, or at least 1 m, or at least 1.5 m, or at least 2.0 m, or at least 2.5 m, or at least 3 m, or at least 4 m, or at least 5 m, or at least 6 m, or at least 7 m, or at least 8 m, of width of crop netting.

38. In some embodiments the crop netting is longer than it is wide and the first region is at least 0.5 m, or at least 1 m, or at least 2 m, or at least 10 m, or at least 20 m, or at least 30 m, or at least 50 m, or at least 100 m, or at least 150 m, or at least 300 m, long.

39. In some embodiments substantially all of the netting is of a pillar knitted construction.

40. In some embodiments the first region is a main body region and the apertures of the main body region of the material are of sufficient size and shape to substantially prevent bees passing through the netting material, said material further comprising a netted window portion comprising apertures of a second aperture size and shape, wherein the apertures of the netted window portion are of sufficient size and shape to allow bees to pass through the netting material and the apertures of the main body region are of sufficient size and shape to substantially prevent bees passing through the netting material.

41. In a sixth aspect the invention provides a crop netting comprising a main body region of knitted pillar construction having pillars spaced at a pillar distance of about or less than 6 mm, or about or less than 8 mm, or about or less than 12 mm, or about or less than 13 mm, and either:
said crop netting further comprising a netted window portion comprising pillars spaced apart by a pillar distance of greater than about 13 mm, or greater than about 14 mm, or greater than about 16 mm, or greater than about 18 mm, or greater than about 20 mm, or greater than about 22 mm, or greater than about 24 mm, or
said crop netting further comprising a netted window portion comprising pillars spaced apart a pillar distance that is greater than 4 mm, or greater than 6 mm, or greater than 8 mm, or greater than 10 mm, or greater than 12 mm, or greater than 14 mm, or greater than 18 mm, or greater than 20 mm, more than the pillar distance between the pillars of the main body region.

42. In some embodiments the netted window portion extends lengthwise along the netting material.

43. In some embodiments the netted window portion extends substantially the full length of the netting material.

44. In some embodiments the netted window portion covers 2 to 30%, or 5 to 30%, or 5 to 20%, or 5 to 15%, or 5 to 10% of the width of the netting material.

45. In some embodiments the netted window portion is at or near a longitudinal edge of the netting material.

46. In some embodiments the netting material comprises a netted window portion at or near both longitudinal edges of the netting material.

47. In some embodiments the netting material comprises one or more netted window portions extending lengthwise along a region located between the longitudinal edges of the netting material.

48. In some embodiments the netted window portion comprises yarns of a higher denier, or are otherwise reinforced to provide additional strength or stretch to the netted window portion.

49. In some embodiments the netted window portion comprises yarns of a denier at least 20%, or 30%, or 40%, or 50% greater than the yarns of the main body region.

50. In some embodiments the netted window portion extends substantially around the perimeter of the netting material.

51. In some embodiments the netted window portion covers 5 to 30%, or 5 to 20%, or 5 to 15%, or 5 to 10% of the width of the netting material and the same or similar width at lateral edges of the netting material.

52. In some embodiments the netted window portion is between 80 mm to 2 m, or 100 mm to 1.5 m, or 200 mm to 1 m wide, or 400 mm to 600 mm wide, or about 0.5 m wide.

53. In some embodiments the netted window portion material extends longitudinally along or near the centre of the width of the netting material.

54. In some embodiments the netted window portion comprises a knitted pillar construction, or a square construction, the pillars of the pillar or square construction running lengthways along the netting material.

55. In some embodiments the netted window portion comprise a knitted pillar construction, the pillars of the pillar construction running lengthways along the netting material.

56. In some embodiments the netted window portion comprises a diamond construction.

57. In a seventh aspect the invention provides a method of producing a crop netting as described above comprising manufacturing said netting on a loom comprising a yarn tension controller, said yarn tension controller adapted to oscillate automatically between a state of higher tension and a state of lower tension.

58. In some embodiments the yarn tension controller is a tension control bar, a creel tension controller, or a bobbin tension controller.

59. In some embodiments the frequency of oscillation is greater than 1 oscillation per 1 mm, or 2 mm, or 5 mm, or 10 mm, or 15 mm, or 20 mm, or 30 mm, or 50 mm, or 80 mm, or 100 mm, or 150 mm, or 200 mm, or 300 mm, or 400 mm, or 500 mm, or 700 mm, or 1 m of length of netting produced.

60. In an eighth aspect the invention provides a loom for knitting a pillar knitted fabric comprising pillar yarns and crossover yarns, said loom comprising, or set up such that it comprises, one or more yarn tension controller for applying tension to either the pillar yarns and/or crossover yarns, at least one of said yarn tension controller adapted such that it may oscillate between a state of higher and lower tension.

61. In some embodiments the oscillation of said one or more yarn tension controllers is mechanically linked to and actuated by the action of the loom.

62. In some embodiments the oscillation of said one or more yarn tension controller is driven by an electrical powered actuator.

63. In some embodiments the oscillation of said one or more yarn tension controllers is controlled by a microprocessor, computer control system or algorithm.

64. In some embodiments the loom comprises or is set up such that it comprises, a first tension control bar for applying a first amount of tension to pillar yarns and a second tension control bar for applying a second amount of tension to crossover yarns.

65. In a ninth aspect the invention provides a loom for knitting a pillar knitted fabric comprising pillar yarns and crossover yarns, said loom comprising, or set up such that it comprises, a first tension control bar for applying tension to pillar yarns and a second tension control bar for applying tension to crossover yarns.

66. In a tenth aspect the invention provides a pillar knitted fabric knitted on a loom as described above.

67. In an eleventh aspect the invention provides a woven crop netting comprising warp yarns and weft yarns, wherein, for at least a first region of the netting, said warp and weft yarns define apertures in said fabric and each aperture is defined at least in part by a section of a first warp yarn (hereinafter ‘first warp section’) and a section of a second warp yarn (hereinafter ‘second warp section’), wherein for at least 25% of said apertures in said first region said first warp yarn section is longer than said second warp yarn section.

68. In some embodiments each aperture comprises a section of a first weft yarn (hereinafter ‘first weft section’) and a section of a second weft yarn (hereinafter ‘second weft section’) and said first and second weft yarn sections are the same length.

69. In some embodiments the first region is a main body region.

70. In some embodiments the crop netting is longer than it is wide and wherein main body region comprises more than about 30%, or more than about 40%, or more than about 50%, or more than about 60%, or more than about 70%, or more than about 80%, or more than about 90%, of the of the width of the crop netting.

71. In some embodiments every second, or every third, or every fourth, or every fifth, or every sixth, warp yarn of said first region is substantially comprised of first warp yarn sections.

72. In some embodiments the first warp yarn sections are longer than said second warp yarn sections by more than 0.08 mm or 0.1 mm, or 0.2 mm, or 0.3 mm, or 0.4 mm, or 0.5 mm, 0.6 mm, or 0.7 mm, or 0.8 mm, or 0.9 mm, 1.0 mm, or 1.1 mm, or 1.2 mm, or 1.4 mm, or 1.6 mm or 1.8 mm, or 2.0 mm, or 2.2 mm, or 3.0 mm, or 4.0 mm.

### Netting With Parallel Secondary Yarns Forming Secondary Apertures

73. In a twelfth aspect the invention provides a crop netting comprising a first region having length and width dimensions and comprising:
a plurality of primary yarns knitted to form a mesh construction having an arrangement of primary apertures defined by yarn intersections and yarn connecting portions between yarn intersections, and
a plurality of secondary yarns, the secondary yarns crossing over the primary apertures to form secondary apertures within the primary apertures, and
wherein at least two secondary yarns cross each of said primary apertures without being crossed by another secondary yarn for substantially all of the length of said at least two secondary yarns as they cross said aperture.

74. In some embodiments said at least two secondary yarns cross each of said primary apertures without being crossed by another secondary yarn over the whole of the primary aperture.

75. In some embodiments said first region is a main body region.

76. In some embodiments two, or three, or four, or five, or six, or seven secondary yarns cross each of said primary apertures without being crossed by another secondary yarn, or without being crossed by another secondary yarn for substantially all of the length of the secondary yarn as it crosses said aperture.

77. In some embodiments the section of a secondary yarn that crosses a primary aperture comprises a midpoint halfway along said section and said midpoint may move at least 2 mm, or at least 3 mm, or at least 4 mm, or at least 5 mm, or at least 6 mm, or at least 7 mm, or at least 8 mm, or at least 9 mm, or at least 10 mm, or at least 11 mm, or at least 12 mm, when said first region is held taut, but not stretched, in said length and width dimensions, when said midpoint is placed under a force back and forth along an axis orthogonal to the crossover yarn.

78. In some embodiments the movement is measured from the natural lie position of the first yarn section and in a direction outward from said aperture along said orthogonal axis, said force being applied in a direction outward from said aperture along said orthogonal axis.

79. In some embodiments the secondary yarns are retained in the netting material by the knitting or knotting or looping of the primary yarns without being knitted, knotted or looped in the yarn connecting portions.

80. In some embodiments the yarn connecting portions comprise:
a secondary yarn which is a lay-in yarn,
a primary yarn being knitted, knotted or looped around the secondary yarn in the yarn connecting portion, and
wherein each secondary yarn passes part way along a yarn connecting portion and extends from the yarn connecting portion to cross over a primary aperture to another yarn connecting portion defining the primary aperture so that at least two secondary yarns cross over each primary aperture to define at least three secondary apertures in each primary aperture.

81. In some embodiments the plurality of primary yarns each extend along a length of the netting in an approximate zig-zag path with alternating yarn intersections and connecting yarn portions, adjacent primary yarns knitted, knotted or looped together at the yarn intersections.

82. In some embodiments the plurality of secondary yarns each extend along a length of the crop netting in an approximate zig-zag path.

83. In some embodiments each secondary yarn extends along the length of the netting material in an approximate zig-zag path at a zig-zag pitch and amplitude the same as a zig-zag pitch and amplitude of the primary yarns, the zig-zag path of each secondary yarn offset along a connecting yarn portion of the mesh construction by a distance so that each secondary yarn crosses over a primary aperture and through yarn intersections along the length of the crop netting.

84. In some embodiments, in a repeating portion of the zig-zag path each secondary yarn extends from a yarn intersection at a first end of a yarn connecting portion, partway along a yarn connecting portion, across a primary aperture, and partway along the yarn connecting portion on the opposite side of the primary aperture to a yarn intersection at a second end of the yarn connecting portion of the opposite side of the primary aperture.

85. In some embodiments the secondary yarn is not knotted or looped in the yarn intersections of the crop netting.

86. In some embodiments the connecting yarn portions comprise:
two or more secondary yarns, each secondary yarn not knotted or looped in the connecting yarn portion,
a primary yarn being knitted, knotted or looped around the two or more secondary yarns in the connecting yarn portion,
wherein the secondary yarns pass part way along the connecting yarn portion and extend from the connecting yarn portion to cross over a primary aperture in a spaced apart relation to another connecting yarn portion defining the primary aperture so that at least two secondary yarns cross over each primary aperture to define at least three secondary apertures in each primary aperture.

87. In some embodiments each of a majority of the connecting yarn portions comprising:
three secondary yarns, each secondary yarn not knotted or looped in the connecting yarn portion,
a primary yarn being knitted, knotted or looped around the secondary yarns in the connecting yarn portion,
wherein the secondary yarns pass part way along the connecting yarn portion and extend from the connecting yarn portion to cross over a primary aperture in a spaced apart relation to another connecting yarn portion defining the primary aperture so that three secondary yarns cross over each primary aperture to define four secondary apertures in each primary aperture.

88. In some embodiments the secondary yarns pass part way along the connecting yarn portion and extend from the connecting yarn portion to cross over a primary aperture in a spaced apart relation to a connecting yarn portion on an opposite side of the primary aperture.

89. In some embodiments the secondary apertures are square, rectangular, or diamond shaped.

90. In some embodiments the netting material comprises rows of the yarn intersections adjacent to one another in a first axis or direction across the netting, and wherein the yarn intersections of the adjacent rows are staggered relative to one another.

91. In some embodiments the netting comprises rows of yarn intersections, said rows extending across either the width of the first region of the netting or along the length of the first region of the netting, the yarn intersections of each row of yarn intersections being staggered or offset with respect to its adjacent row of yarn intersections.

92. In some embodiments the first direction is across a machine or manufacturing axis or direction of the netting and the second direction is the machine or manufacturing axis or direction of the netting.

93. In some embodiments the primary apertures have four sides, each primary aperture defined by four yarn connecting portions.

94. In some embodiments the primary apertures have six sides, each primary aperture defined by six yarn connecting portions.

95. In some embodiments the primary yarn is physically stronger than the secondary yarn.

96. In some embodiments the primary apertures have a perimeter of length 20 to 160 mm, or 20 to 100 mm, or 40 to 90 mm, or 50 to 85 mm.

97. In some embodiments either one or both of said primary or secondary yarns have a mass of 50 to 1000 denier, or 100 to 800 denier, or 200 to 800 denier, or 300 to 700 denier, or 400 to 600 denier.

98. In some embodiments the weight of the netting is in the range of approximately 10 to 150 gsm, or 40 to 120 gsm, or 60 to 100 gsm.

99. In some embodiments said primary apertures have an aperture size of about 6mm to about 72 mm, or about 8 mm to about 64 mm, or about 10 mm to about 56 mm, or about 12 mm to about 48 mm, or about 16 mm to about 40 mm, or about 16 mm to about 32 mm, or about 24 mm+/−6 mm.

100. In some embodiments said secondary apertures have an aperture size of less than 8 mm, or less than 7 mm, or less than 6 mm, or less than 5 mm, or less than 4 mm, or less than 3 mm, or less than 2 mm.

Netting with Secondary Yarns Forming Secondary Apertures—Secondary Yarns in One Direction Crossing All Above, or All Below, Secondary Yarns in another Direction

101. In a thirteenth aspect the invention provides a crop netting comprising a first region comprising:
a plurality of primary yarns knitted to form a mesh construction having an arrangement of primary apertures defined by yarn intersections and yarn connecting portions between yarn intersections, and
a plurality of secondary yarns, said plurality of secondary yarns crossing over said primary apertures to form secondary apertures within said primary apertures, and
wherein said plurality of secondary yarns comprise first direction secondary yarns, at least two crossing each aperture, which cross from the same one side of each primary aperture to an opposing side of the same primary aperture; and
wherein said plurality of secondary yarns also comprise intersecting secondary yarns that cross said first direction secondary yarns within said primary apertures; and
wherein within said primary apertures said intersecting secondary yarns cross either under all, or cross over all, said first direction of secondary yarns.

102. In some embodiments, within said primary apertures, said first direction of secondary yarns are substantially parallel to each other.

103. In some embodiments said intersecting secondary yarn crosses said first direction secondary yarns at approximately 90° to said first direction secondary yarns.

104. In some embodiments said primary apertures are crossed by one intersecting secondary yarn.

105. In some embodiments said first direction secondary yarns comprises two, or three, or four, or five, or six, or seven, or eight, secondary yarns.

106. In some embodiments said primary apertures are crossed by two, or three, or four, or five, or six, or seven, or eight, intersecting secondary yarns, and both or all of said intersecting secondary yarns either cross under, or all cross over, said first direction secondary yarns.

107. In some embodiments said two, or three, or four, or five, or six, or seven, or eight, intersecting secondary yarns are substantially parallel to each other within said primary aperture.

108. In some embodiments said first region is a main body region.

109. In some embodiments said first direction secondary yarns and/or said intersecting secondary yarns are retained in the netting material by the knitting or knotting or looping of the primary yarns without being knitted, knotted or looped in the yarn connecting portions.

110. In some embodiments each of a majority of the yarn connecting portions comprise:
a secondary yarn which is a lay-in yarn,
a primary yarn being knitted, knotted or looped around the secondary yarn in the yarn connecting portion,
wherein each secondary yarn passes part way along a yarn connecting portion and extends from the yarn connecting portion to cross over a primary aperture to another yarn connecting portion defining the primary aperture so that at least two pairs of secondary yarns cross over each primary aperture to define at least nine secondary apertures in each primary aperture.

111. In some embodiments the plurality of primary yarns each extend along a length of the netting in an approximate zig-zag path with alternating yarn intersections and connecting yarn portions, adjacent primary yarns knitted, knotted or looped together at the yarn intersections.

112. In some embodiments the plurality of secondary yarns each extend along a length of the netting material in an approximate zig-zag path.

113. In some embodiments each secondary yarn extends along the length of the netting material in an approximate zig-zag path at a zig-zag pitch and amplitude the same as a zig-zag pitch and amplitude of the primary yarns, the zig-zag path of each secondary yarn offset along a connecting yarn portion of the mesh construction by a distance so that each secondary yarn crosses over a primary aperture and through yarn intersections along the length of the netting material.

114. In some embodiments, in a repeating portion of the zig-zag path, each secondary yarn extends from a yarn intersection at a first end of a yarn connecting portion, partway along a yarn connecting portion, across a primary aperture, and partway along the yarn connecting portion on the opposite side of the primary aperture to a yarn intersection at a second end of the yarn connecting portion of the opposite side of the primary aperture.

115. In some embodiments the secondary yarn is not knotted or looped in the yarn intersections of the netting material.

116. In some embodiments each of a majority of the connecting yarn portions comprise:
two or more secondary yarns, each secondary yarn not knotted or looped in the connecting yarn portion,
a primary yarn being knitted, knotted or looped around the two or more secondary yarns in the connecting yarn portion,
wherein the secondary yarns pass part way along the connecting yarn portion and extend from the connecting yarn portion to cross over a primary aperture in a spaced apart relation to another connecting yarn portion defining the primary aperture so that at least two pairs of secondary yarns cross over each primary aperture to define at least nine secondary apertures in each primary aperture.

117. In some embodiments each of a majority of the connecting yarn portions comprise:
one pair of secondary yarns, each secondary yarn not knotted or looped in the connecting yarn portion,
a primary yarn being knitted, knotted or looped around the pair of secondary yarns in the connecting yarn portion,
wherein the secondary yarns pass part way along the connecting yarn portion and extend from the connecting yarn portion to cross over a primary aperture in a spaced apart relation to another connecting yarn portion defining the primary aperture so that two pairs of secondary yarns cross over each primary aperture to define nine secondary apertures in each primary aperture.

118. In some embodiments the secondary yarns pass part way along the connecting yarn portion and extend from the connecting yarn portion to cross over a primary aperture in a spaced apart relation to a connecting yarn portion on an opposite side of the primary aperture.

119. In some embodiments the secondary apertures and the primary apertures have the same or similar aspect ratio.

120. In some embodiments the netting material comprises rows of the yarn intersections adjacent to one another in a first axis or direction across the netting, and wherein the yarn intersections of the adjacent rows are staggered relative to one another.

121. In some embodiments the netting comprises rows of yarn intersections, said rows extending across either the width of the netting material or along the length of netting material, the yarn intersections of each row of yarn intersections being staggered or offset with respect to its adjacent row of yarn intersections.

122. In some embodiments the first direction is across a machine or manufacturing axis or direction of the netting and the second direction is the machine or manufacturing axis or direction of the netting.

123. In some embodiments the primary apertures have four sides, each primary aperture defined by four yarn connecting portions.

124. In some embodiments the primary apertures have six sides, each primary aperture defined by six yarn connecting portions.

125. In some embodiments the primary yarn and/or the secondary yarn is an opaque yarn formed from a resin comprising at least one pigment.

126. In some embodiments the primary yarn and/or the secondary yarn is white, the pigment being a white pigment.

127. In some embodiments the white pigment is be present in the form of particles of size 0.02-5 microns or 0.1-3 microns.

128. In some embodiments the primary yarn and/or the secondary yarn is translucent or transparent.

129. In some embodiments the primary and/or the secondary yarn is UV reflecting.

130. In some embodiments the primary and/or the secondary yarn reflects at least 10% on average of UV across the wavelength rage 280 to 400 nm.

131. In some embodiments the primary and/or the secondary yarn absorbs at least 60%, on average, of solar radiation across the range 280 to 4000 nm.

132. In some embodiments the primary and secondary yarns are of different physical strengths.

133. In some embodiments the secondary yarn is physically stronger than the primary yarn.

134. In some embodiments the primary yarn is physically stronger than the secondary yarn.

135. In some embodiments the primary yarn is reflective.

136. In some embodiments the primary yarn and secondary yarn have different reflectance, absorbance and/or transmittance characteristics.

137. In some embodiments the primary apertures have a perimeter of length 20 to 160 mm, or 20 to 100 mm, or 40 to 90 mm, or 50 to 85 mm.

138. In some embodiments either one or both of said primary or secondary yarns have a mass of 50 to 1000 denier, or 100 to 800 denier, or 200 to 800 denier, or 300 to 700 denier, or 400 to 600 denier.

139. In some embodiments the weight of the netting is in the range of approximately 10 to 150 gsm, or 40 to 120 gsm, or 60 to 100 gsm.

140. In a fourteenth aspect the invention provides a crop netting comprising a first region comprising:
a plurality of primary yarns knitted to form a mesh construction having an arrangement of primary apertures defined by yarn intersections and yarn connecting portions between yarn intersections, and
a plurality of secondary yarns, said plurality of secondary yarns crossing over said primary apertures to form secondary apertures within said primary apertures, and
wherein said plurality of secondary yarns comprise substantially parallel secondary yarns which are substantially parallel to each other within said primary apertures; and
wherein said plurality of secondary yarns also comprise intersecting secondary yarns that cross said substantially parallel secondary yarns within said primary apertures; and
wherein within said primary apertures said intersecting secondary yarns cross either all under, or all over, said at substantially parallel secondary yarns.

Advantages of the above invention, at least in some aspects or embodiments, include the provision of a material with improved hail release performance.

The term “aperture size”, as used herein, unless the context suggests otherwise, means the diameter of the largest circle that can be scribed within an average typical aperture in a netting, the average typical aperture being a hypothetical aperture that represents an average of apertures that are typical of the netting (or applicable region of netting for a netting with different regions), when the netting is taut in both a lateral and a longitudinal direction but not stretched, or in a state to which the netting may be reasonably expected to be stretched once installed. For example, for a square aperture, the size of the aperture is the length of a side, and for a rectangular aperture, the aperture size is the length of the shorter side of the aperture. So the aperture size of a square aperture with 5 mm sides is 5 mm, and the aperture size of a 5 mm by 10 mm aperture is also 5 mm. An equilateral triangle with sides of approximately 8.7 mm and the aperture size of a hexagonal aperture with sides of approximately 2.9 mm are also examples of apertures having a size of 5 mm. An aperture may be irregularly shaped, the above regularly shaped apertures are provided as examples only. The applicant recognises that in use a netting may be installed such that it is stretched so that the apertures are larger than what they would be if the netting is in a taut but unstretched state. Nettings that have been installed such that they have aperture sizes that fall within the ranges claimed herein, or nettings that may be reasonably stretched such that on installation they would have aperture sizes that fall within the ranges claimed herein, should be considered to fall within the ranges claimed herein.

The term “cover factor” as used herein means the percentage of the total area of the material which comprises yarn forming the material itself, judged from perpendicular to the plane of the material when laid out flat, as opposed to air space in between the yarns from which the material is formed. Thus if a material has a cover factor of 30% then the air space through the material would be 70% of the total area of the material.

The term “yarn” as used herein, unless the context suggests otherwise, means multi or mono filament yarn, threads or fibres. The term “yarn” unless the context suggests otherwise, includes longitudinally extending single filament elements having four sides when viewed in cross-section, such as a rectangular or square cross-section, also longitudinally extending elements having a multisided cross-section such as a triangular or hexagonal cross-section for example, and also longitudinally extending elements having a circular or oval or similar cross-section (sometimes referred to hereafter as monofilament). The term “yarn” includes tape, unless the context suggests otherwise. In some embodiments, the term “yarn” excludes lay-in yarns.

The term “lay-in yarn”, as used herein, unless the context suggests otherwise, is a yarn that is knitted or woven through at least some of the yarn intersections and/or connecting portions defining the primary apertures that make up the mesh construction of a knitted netting material, said yarn intersections and/or connecting portions forming the basic knit structure of such material, and is additional to, rather than a basic structural element of said basic knit structure. Optionally, the lay-in yarn is not looped back on itself more than 180 degrees in the primary direction of travel or knitting direction. Sometimes the lay-in yarn may loop more than 180 degrees in the primary direction of travel of knitting direction, for example, it may loop 360°. If the lay-in yarn is removed the net's inherent structure will stay intact. It is supported by the basic yarn knitted structure. A lay-in yarn is also referred to herein as a “secondary yarn”. A lay-in yarn may be arranged to cross a primary aperture (term defined below), or may be arranged to follow the perimeter of a primary aperture.

The term “sheet”, as used herein, means includes knitted, woven or non-woven material in sheet form (which can be draped for example).

The term “primary aperture” is used in this specification. The term may be used in the context of knit patterns comprising a lay-in yarn, and may be used to distinguish the apertures of the basic knit structure (i.e. ignoring lay-in yarns) from the apertures of the knit structure formed by the lay-in yarns. For example, when considering a diamond basic knit pattern with a lay-in yarn dividing each diamond shaped aperture of the knit pattern in half, the primary aperture is the diamond shaped aperture, which is divided by the lay-in yarn to form two smaller apertures.

The term “basic knit structure” is also used in this specification. The term may be used in the context of nettings comprising a lay-in yarn(s), and refers to the knit pattern ignoring any lay-in(s).

The term “pigment” as used herein means a compound or compounds which may be added to a polymer to alter the solar radiation reflectance, absorbance and/or transmittance properties of the resulting pigment-polymer product formed, in particular across the wavelength ranges 280-400 nm, 400-700 nm, 700 to 2500 nm, and/or 2500 to 25,000 nm. The term includes compounds that may alter solar radiation reflectance, absorbance and/or transmittance properties but have no colour.

In some embodiments, a yarn or yarn section discussed herein as “extending generally” in a width dimension, or grammatical equivalents thereof, means that that the yarn extends more in the width dimension than it does in the length dimension, unless the context otherwise requires. Similarly, in some embodiments a yarn or yarn section “extending generally” in a length dimension, or grammatical equivalents thereof, means that that the yarn extends more in the length dimension than it does in the width dimension, unless the context otherwise requires. In some embodiments a yarn that is orientated at 45° to length and width dimensions such that it could be considered to extend in both or neither length or width dimensions should be considered to extend in either or both said dimensions.

The phrase “mesh size” as used in this specification and claims, unless the context suggests otherwise, is defined for the four-sided and equal-length sides form of mesh apertures as the length of the sides of the mesh aperture, or a substantially equivalent cross-sectional area for non-equi-length sided mesh apertures or other more complex mesh aperture shapes formed by more than four sides, the cross-sectional area being determined when the netting is taut but not stretched, in both directions.

The terms “length” is used herein to describe a longitudinal dimension of a crop netting. The term “width” is used to describe a lateral dimension of a crop netting.

The term “comprising” as used herein means “consisting at least in part of”. When interpreting each statement in this specification that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

The term ‘substantially’ or grammatical variations thereof refers to at least about 50%, for example 75%, 85%, 95% or 98%.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

FIG. 1 is a schematic illustration of a prior art netting material having a spacing between pillars of 8 mm, and a distance along the pillars between crossovers of 5 mm, and the crossover sections between pillars of the same length.

FIG. 2 is a schematic illustration of a prior art crop netting material after a hail storm.

FIG. 3 is a schematic illustration of a netting material of the invention having a spacing between pillars of 24 mm, and a distance along the pillars between crossovers of 5 mm;

FIG. 4 is a schematic illustration of a netting material of the invention comprising crossover sections of different lengths.

FIG. 5 is a schematic illustration of a crop netting material of one aspect of the invention without hailstone.

FIG. 6 is the same netting as illustrated in FIG. 5 illustrating a longer crossover section moving under the weight of a hailstone and allowing passage of the hailstone through the netting.

FIG. 7 is a schematic illustration showing an enlarged view of an embodiment of the invention having different length crossover sections between adjacent pillars, illustrating in detail the path and knotting of the yarns.

FIG. 8 is a schematic illustration of a netting material of the invention comprising crossover sections of different lengths wherein the crossovers are grouped into pairs of shorter crossovers sections and pairs of longer crossovers sections.

FIG. 9 is a schematic illustration of a netting material of the invention comprising crossover sections of different lengths where the crossovers are grouped into groups of 4 shorter crossover sections and groups of 4 longer crossover sections.

FIG. 10 is a schematic illustration of a netting material of the invention comprising dual crossover yarns between each pair of pillars, one yarn in each of the dual crossover yarns having crossover sections longer than the other for alternate crossover sections of that yarn.

FIG. 11 is a schematic illustration of a netting material of the invention comprising dual crossover yarns between each pair of pillars, one yarn in each of the dual crossover yarns having crossover sections longer than crossover sections of the other yarn.

FIG. 12 is a schematic illustration of a netting material of the invention comprising crossover yarns spanning more than two pillars, and where some crossover yarns are knitted with shorter crossover sections and other crossover yarns are knitted with longer crossover sections.

FIG. 13 is the same schematic illustration as FIG. 12 but has the path of two crossover yarns highlighted to further illustrate the path of individual crossover yarns.

FIG. 14 is a schematic illustration of a netting material of the invention that has been woven, in particular has been woven in a leno-weave construction.

FIG. 15 is a schematic illustration of a netting material of the invention comprising bands of larger pillar spacing construction extending the length of the material.

FIG. 16 is a schematic illustration of a netting material of the invention comprising a plain weave construction wherein every other warp yarn is loose such that the size of each aperture can change as a hail stone passes through the material.

FIG. 17 is a schematic diagram of crop protection netting fully covering a row of plants.

FIG. 18 is a schematic diagram of crop protection netting partially covering a row of plants.

FIG. 19 is a plan view of a portion of netting in a taut but unstretched state in accordance with an embodiment of the invention.

FIG. 20 is a plan view of a portion of netting in a taut but unstretched state in accordance with an embodiment of the invention, with primary yarns of the netting shown in outline.

FIG. 21 is a plan view of a single intersection of netting depicted in FIGS. 19 and 20.

FIG. 22 is a plan view of a larger portion of netting as depicted in FIGS. 19 and 20 with primary yarns of the netting shown in outline and with the path of certain secondary yarns of the netting indicated.

FIG. 23 is a plan view of a portion of netting as depicted in FIGS. 19 and 20 but with bending or curvature of secondary yarns in the netting exaggerated for ease of displaying the path of the secondary yarns through the netting material.

FIG. 24 is a schematic illustration of a crop netting material of one aspect of the invention without hailstone.

FIG. 25 is the same netting as illustrated in FIG. 24 illustrating a secondary yarns moving under the weight of a hailstone and allowing passage of the hailstone through the netting.

FIG. 25a is a schematic illustration of a prior art netting similar to the netting of FIG. 24, but which includes pairs of secondary yarns crossing each primary aperture orthogonally to each other, and illustrating a hailstone sitting on the upper side of the netting.

FIG. 26 is a schematic illustration of further embodiments of a netting comprising parallel secondary yarns.

FIG. 27 is a schematic illustration of a prior art netting, illustrating interwoven crossovers.

FIG. 28 is a schematic illustration of another aspect of the invention illustrating secondary yarns crossing a primary aperture in opposing directions without any interweaving within said aperture.

FIGS. 29 & 30 illustrate other embodiments of the invention where secondary yarns cross a primary aperture from opposing directions without any interweaving within said aperture.

### DETAILED DESCRIPTION

Described above are crop nettings and embodiments thereof having widely spaced pillars and/or crop nettings having crossover sections of different length. Particular embodiments of such materials are now described in further detail.

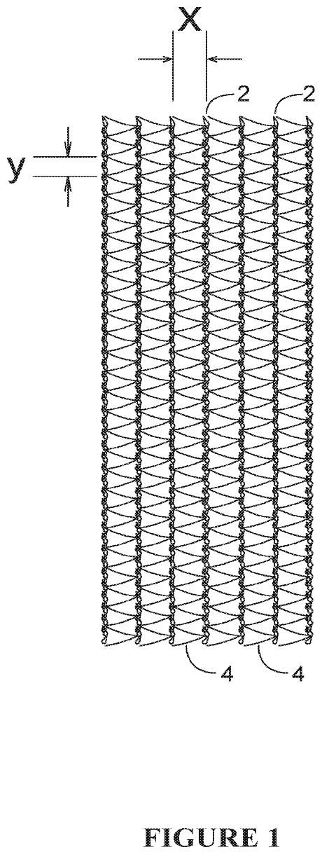

FIG. 1 illustrates a prior art crop netting material having a spacing between pillars (distance X) of 8 mm, and a distance along the pillars between crossovers (distance Y) of 5 mm. In horticultural applications, prior art materials typically have spacing between pillars of 3 to 12 mm; 8 mm or 12 mm being typical for the main body of such nettings, with 3-4 mm sometimes used to provide reinforcing along the lateral edges.

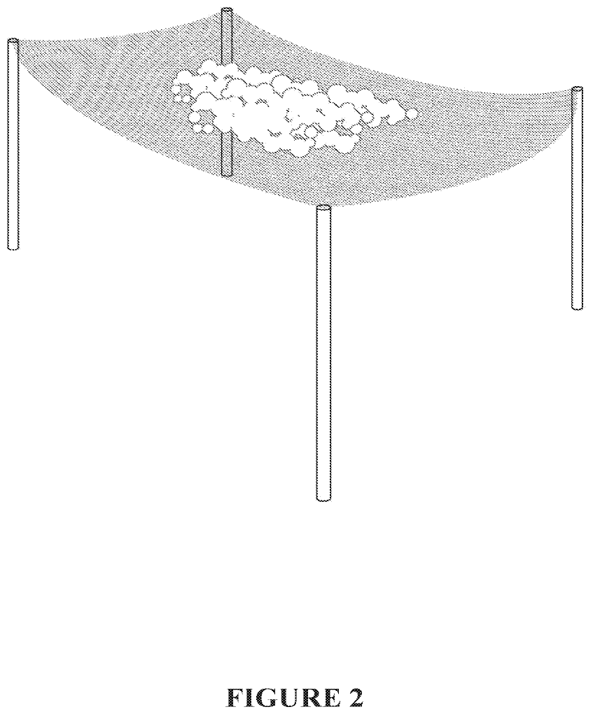

FIG. 2 illustrates a prior art netting, such as may be installed above a crop, after a hail storm. As illustrated, the weight of accumulated hail applies stress to both the netting and its supporting structure. Eventually, excessive weight may damage the netting or its supporting structure.

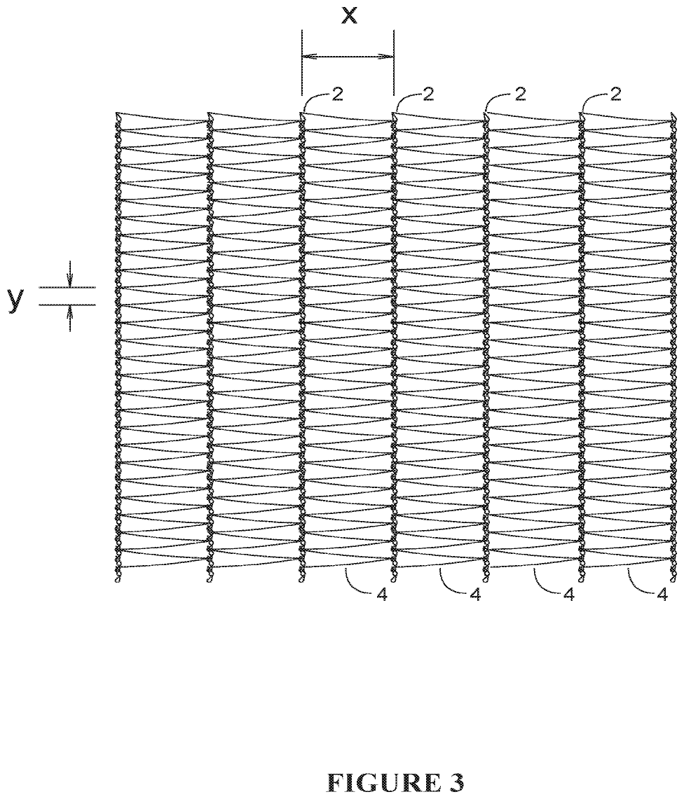

FIG. 3 illustrates a netting material of an embodiment of one aspect of the invention. The netting comprises a plurality of pillars of knitted yarn 2, spaced apart from each other (distance X in FIG. 3) by 24 mm (measured from the centre of one pillar to the centre of the next, and hereinafter referred to as ‘pillar distance’). Each pillar 2 is comprised of one yarn that loops upon itself along the length of the pillar (hereinafter ‘pillar yarn’) and is connected to an adjacent pillar of similar construction to one side of the pillar by a yarn 4 (hereinafter ‘crossover yarn’) that crosses back and forth between the pillar and an immediately adjacent pillar along the length of the pillars. A similar construction exists on the opposite side of each pillar (other than for the pillars at each side edge of the material) such that each pillar 2 is connected to a pillar to its left and right, and forms a fabric comprising a plurality of pillars 2 connected by crossover yarns 4 extending the length of the pillars. The crossover yarns 4 are knitted into the pillar such that each pillar comprises a pillar yarn, being a yarn that runs the length of the pillar, and two crossover yarns (one from each side) which loop and or knot into the pillar at intervals, normally regular intervals, along the length of the pillar. In the embodiment illustrated in FIG. 3, the distance between two successive points along a pillar where a single crossover yarn enters the pillar (hereinafter ‘crossover distance’) is 5.0 mm. Another way of expressing this is that each crossover yarn crosses back and forth between two adjacent pillars along the length of pillars at a frequency (hereinafter ‘crossover frequency’) of 400 crosses per meter (based on crossing back and forth once equalling two crosses). The relatively large pillar distance and consequential length of crossover yarns traversing that distance provides increased ability for passage of hailstones through the apertures of the netting, than when compared to prior art of smaller pillar distance (e.g. pillar distance of 12 mm), even if the nettings have the same aperture size. More specifically, the longer the length of the section of a crossover yarn located between two immediately adjacent pillars (hereinafter ‘crossover sections’) the greater the ability of that crossover section to move under the weight of a hailstone to allow passage of that hailstone. This is due to in part because a longer crossover section can be more readily displaced thereby enabling hail to move though the net. The tension of a crossover section also plays a role in allowing a hail stone to push/displace the crossover section to allow passage though the net.

In some embodiments, the pillars are spaced at a distance of between 13 and 30 mm, or larger. Such wider pillar distances may be preferred because a small proportion increase in crossover section length for some crossover sections may allow such sections a larger degree of movement (and therefore a greater ability to allow hailstone passage) than would be achieved for the same proportion increase for shorter crossover sections located between more closely spaced pillars (e.g. pillars 8 mm apart).

In some embodiments crop netting as claimed in any preceding claim wherein the pillars are separated by a pillar distance of greater than about 13 mm, or greater than about 14 mm, or greater than about 15 mm, or greater than about 16 mm, or greater than about 17 mm, or greater than about 18 mm, or greater than about 19 mm, or greater than about 20 mm, or greater than about 22 mm, or greater than about 24 mm, or greater than about 26 mm, or greater than about 28 mm, or a separated by a pillar distance of between about 3 mm and about 48 mm, or between about 13 mm and about 48 mm, or between about 14 mm and about 48 mm, or between about 16 mm and about 48 mm, or between about 18 mm and about 48 mm, or between about 20 mm and about 48 mm, or between about 22 mm and about 48 mm, or a separated by a pillar distance of between about 3 mm and about 56 mm, or between about 13 mm and about 56 mm, or between about 14 mm and about 56 mm, or between about 16 mm and about 56 mm, or between about 18 mm and about 56 mm, or between about 20 mm and about 56 mm, or between about 22 mm and about 56 mm, or a separated by a pillar distance of between about 3 mm and about 64 mm, or between about 13 mm and about 64 mm, or between about 14 mm and about 64 mm, or between about 16 mm and about 64 mm, or between about 18 mm and about 64 mm, or between about 20 mm and about 64 mm, or between about 22 mm and about 64 mm, or between about 6 mm and about 44 mm, or between about 8 mm and about 42 mm, or between about 10 mm and about 40 mm, or between about 14 mm and about 40 mm, or between about 14 mm and about 38 mm, or between about 16 mm and about 34 mm, or between about 16 mm and 35 mm, or between about 16 mm and about 30 mm, or between about 18 mm and about 32 mm, or between about 20 mm and about 28 mm, or between about 16 mm and 28 mm, or between about 18 mm and about 26 mm, or between about 20 mm to 26 mm, or between about 22 mm and about 26 mm or about 24 mm, or within a range of 24 mm+/−6 mm, or within a range of 28 mm+/−6 mm, or within a range of 32 mm+/−6 mm, or within a range of 36+/−6 mm, or within a range of 48 mm+/−6 mm, or within a range of 56 mm+/−6 mm, or within a range of 64 mm+/−6 mm.

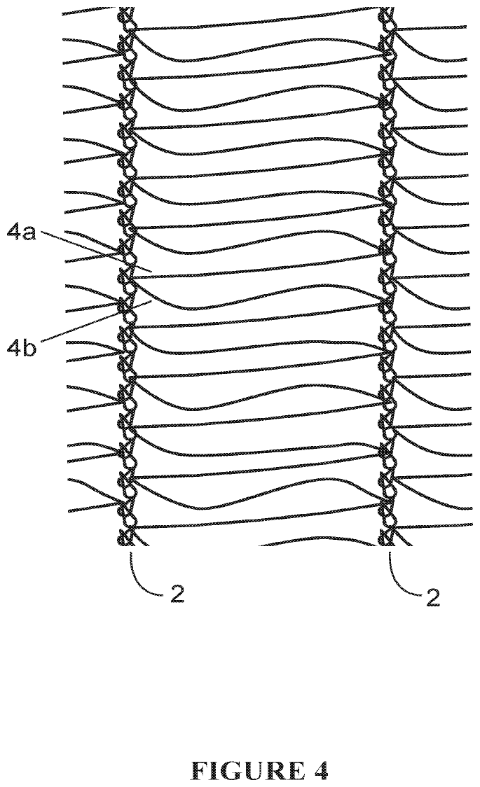

FIG. 4 illustrates a netting according to an embodiment of another aspect to the invention. The netting has the same basic knitted pillar construction as described above except that crossover sections differ in length between two adjacent pillars. This means that when the material is installed and tension is applied across the material (i.e. in a direction roughly orthogonal to the length of the pillars and in the plane of the material) some crossover sections bear more tension between two adjacent pillars and others bear less, little, or no tension. In such embodiments the pillar distance may be more or less than 12 mm or 13 mm. For example the pillar distance could be about 4 mm, or about 8 mm, or about 12 mm, or about 16 mm, or about 18 mm, or about 24 mm or more. In the embodiment illustrated, the crossover sections are arranged in pairs of one shorter (4a) and one longer (4b), such that the shorter crossover sections (4a) (i.e. the ones which will bear more tension) are equally distributed along the length of the space between two pillars (2). The longer crossover sections (4b) have a greater freedom of movement even when the fabric is installed under tension, and when hail falls upon the material such crossover sections have the ability to move more and rearrange their position in response to the weight of a hailstone or hailstones. This means that more hailstones may pass though the material than would for a material of similar construction with crossover sections of the same length.

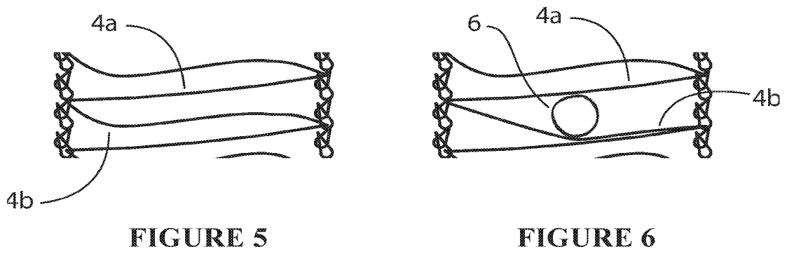

FIG. 5 is a schematic illustration of a crop netting material of a section of netting of FIG. 4 without hailstone. FIG. 6 is the same netting as illustrated in FIG. 5 illustrating a longer crossover section 4b moving under the weight of a hailstone 6 and allowing passage of the hailstone through the netting.

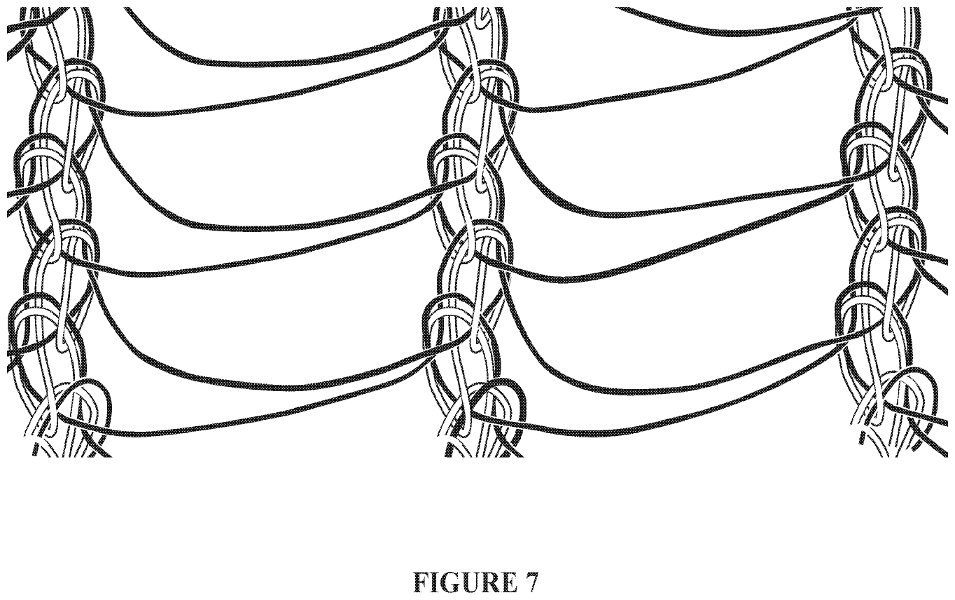

FIG. 7 is a schematic illustration showing in detail the knotting of a netting according to the embodiment of FIG. 4. More specifically, the passage of the pillar yarns (illustrated in white) and crossover yarns (illustrated in black), and how they knot with each other, is shown.

A pillar knitted fabric may have construction forms other than those described above, and such other forms are included within the scope of the invention. For example, a pillar may comprise more than one pillar yarn, or more than one crossover yarn may cross back and forth between the same two pillars. Also, the crossover yarns, instead of crossing back and forth between two immediately adjacent pillars (i.e. across the space between two pillars), may cross back and forth between two pillars that are not immediately adjacent to each other (i.e. may cross back and forth across spaces between more than two pillars). The crossover yarns may cross between pillars at an angle (i.e. forming a zig zag type pattern), or they may cross between pillars at 90° to the pillar, in which case they are also typically knitted along, or follow along, the length of the pillar for a short section before crossing back again.

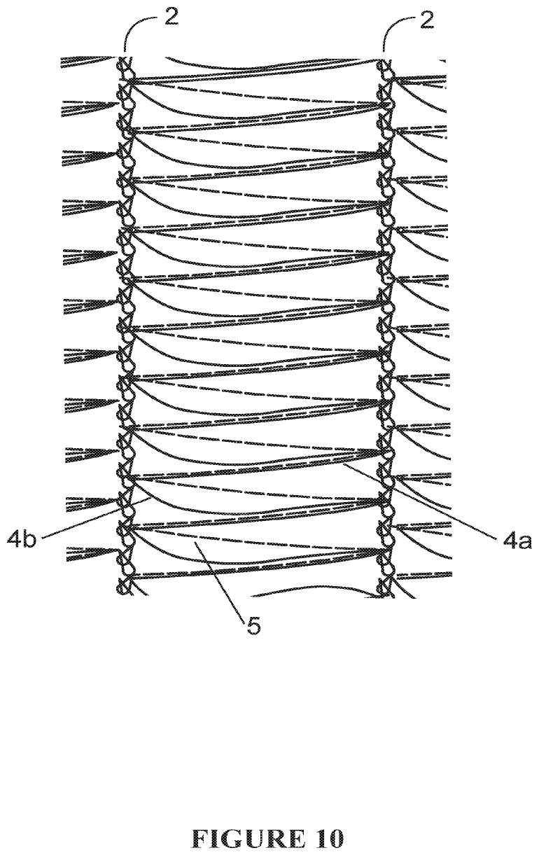

In some embodiments, two or more crossover yarns cross back and forth across the space between two pillars. FIG. 10 illustrates a netting according to another embodiment of the invention. The netting of FIG. 10 has a similar structure as that of FIG. 4, but rather than a singular crossover yarn crossing back and forth between two pillars, it comprises dual (or a pairing of) crossover yarns crossing back and forth between two pillars. In the embodiment of FIG. 10, a first crossover yarn (represented by a solid line) of each pairing is knitted such that the crossover yarn comprises pairs of shorter 4a and longer 4b crossovers sections extending along the length of the space between two pillars 2, and the second crossover yarn 5 (represented by a dashed line) of each pairing is knitted such that the crossover sections of that yarn are all the same length, that length being the same as the shorter crossover sections of the first crossover yarn.

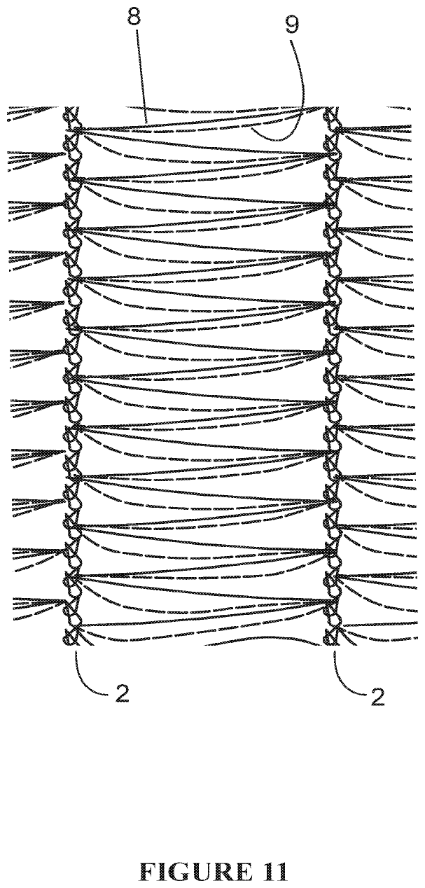

FIG. 11 illustrates a netting according to another embodiment of the invention. The netting of FIG. 11 comprises dual (or a pairing of) crossover yarns crossing back and forth between two pillars. In the embodiment of FIG. 11, a first crossover yarn 8 (represented by a solid line) of each pairing is knitted such that the crossover yarn comprises crossovers sections of the same length extending along the length of the space between two pillars 2, and the second crossover yarn 9 (represented by a dashed line) of each pairing is knitted such that the crossover sections of that yarn are longer than those of the first crossover yarn.

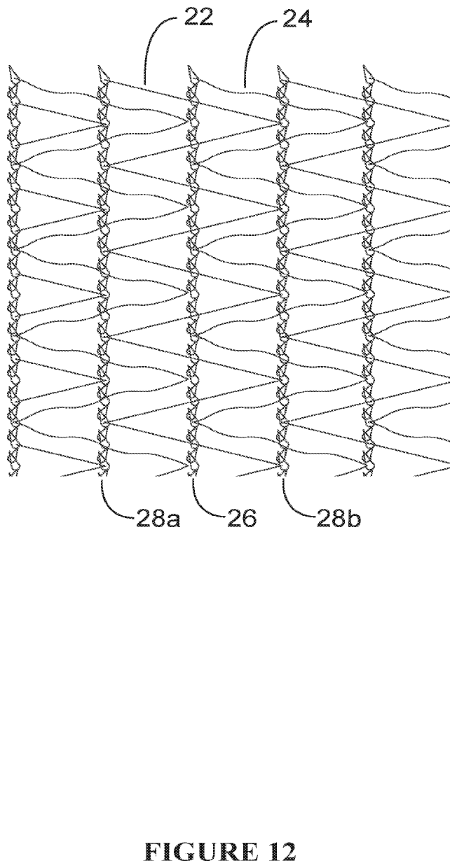

FIG. 12 illustrates a further embodiment of the invention. As illustrated in FIG. 12, crossover yarns may be arranged such that each crosses back and forth across the width of, for example, three pillars (i.e. back and forth across a grouping of two boundary pillars 28a, 28b and an intermediate pillar 26 located between them), and being knotted at each pillar 26, 28a, 28b. Each intermediate pillar 26 may form a boundary pillar for another crossover yarn crossing back and forth between a neighbouring (and partially overlapping) group of three pillars to repeat the knit pattern. In such embodiments, one crossover yarn 22 may be knitted such that the crossover sections between the pillars are shorter and the next crossover yarn 24 is knitted such that the crossover sections between the pillars are longer. Thus, the crossover yarns may be essentially arranged in pairs 22,24 where one crossover yarn 22 holds the tension across the netting when installed, and the other 24 bears less or none of such tension such that it has more freedom to move in response to the weight or strike of a hailstone. That is, under the weight of the hailstone the looser crossover sections move sideways and allow the hail to move though the net to the ground beneath the net.

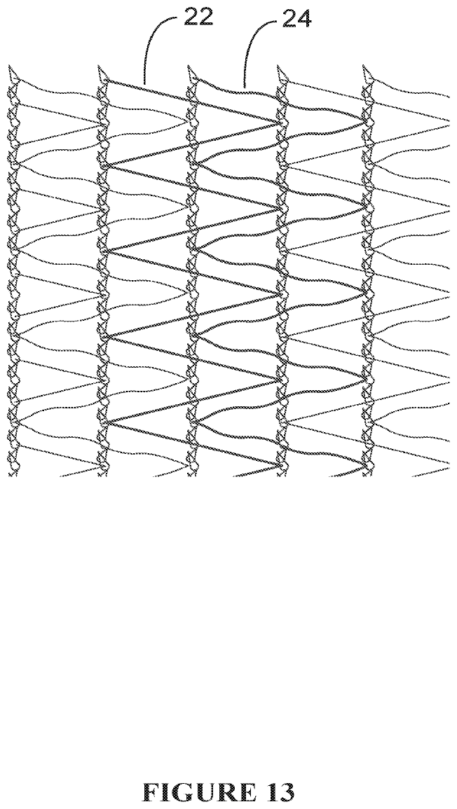

In FIG. 13, the path of two crossover yarns has been highlighted to further illustrate the embodiment described in FIG. 12. Of the two highlighted yarns, the one on the left 22 has shorter crossover sections and follows a zig-zag path across the width of three pillars (i.e. across the gaps between three pillars), and the one on the right 24 has longer crossover yarns and also follows a zig zag path similar to that of the highlighted crossover yarn on the left, but offset to the right by the width of one pillar distance or pillar space. The crossover sections of the yarn 24 on the right of two highlighted yarns have longer crossover sections and a greater freedom of movement when the netting is installed, and are able to shift in response to the weight of a hailstone thereby allowing passage of the hailstone.

Other constructions may be employed where crossover yarns cross back and forth over a width of more than three pillars, or where crossover yarns cross back and forth over a width or three pillars or more and are knotted at selected pillars (and not others), or are knotted at selected positions along pillars.

The crossover yarns or the pillars may comprise yarns of circular cross-section, or other shaped cross-section, or tapes, or combinations thereof.

The netting of the embodiment illustrated in FIG. 3 is formed from yarns having a denier of approximately 550 and a mass of 40 gsm. The netting has a cover factor of approximately 18%.

Other weight yarns that may be used in the invention include those having a denier of between 100 and 3500, or 100 and 2500, or 100 and 2000, and 100 and 1500, or 100 and 1000, or 150 and 800, or 200 and 700, or 200 and 600, or 200 and 300, or 450 and 550, or about 250, or about 500. In some embodiments the crossover yarns have a denier less than the pillar yarns. In some embodiments the crossover yarns have a denier of between 100 and 350 denier, and the pillar yarns have a greater denier.

Any one of yarn denier, crossover distance, and pillar distance may be varied to give different weight nettings. For example, the mass of the netting may be between 20 and 400 gsm, or 40 and 350 gsm, or 40 and 300 gsm, or 40 and 250 gsm, or 40 and 200 gsm, or 60 and 180 gsm, or 80 and 140 gsm. Crossover distance may be between 2 and 12 mm, 2 and 10 mm, 2 and 8 mm, 3 and 6 mm, or about 5 mm.

The crop protection netting may have a cover factor (as herein defined) of less than 30%, less than 20%, less than 10%, or less than 5%. The crop protection netting may have a cover factor of 5 to 30%, or 30 to 60%, or 60 to 85%, or 85 to 95%, 95 to 100%, or 5 to 98%, or greater than 5%.

A netting in the form of a pillar knitted fabric is typically machine-knitted on a warp knitting machine or other knitting-machine. The netting comprises an array of apertures. The apertures of the netting of FIG. 3 have an aperture size (as defined herein) of 4.6 mm.

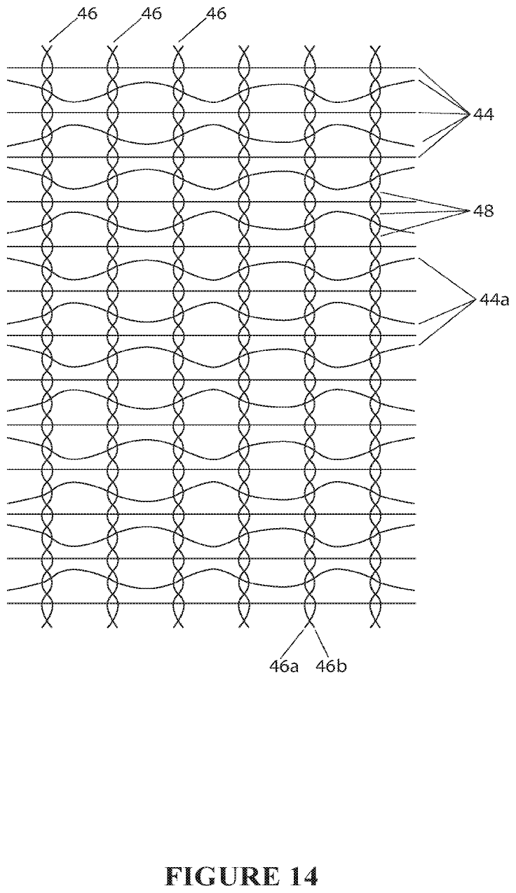

Crop nettings of the invention may also be formed from woven materials. FIG. 14 illustrates a schematic view of one such embodiment of a crop netting material of the invention. As illustrated, the material has weft yarns (44) and pairs (46) of warp yarns (46a, 46b), the pairs of warp yarns (46) forming pillars extending in the length of the material and spaced apart across the width of the material. The two warp yarns (46a, 46b) in each pair of warp yarns(46) cross at a cross-over point (48) between adjacent weft yarns (44) so that the warp yarns extend over and under adjacent weft yarns alternatively. This type of construction is known in the art as a leno weave. In the embodiment of the invention illustrated, every other weft yarn is woven such that the portions of the weft yarn located between two pillars (i.e. crossover sections) is longer than the equivalent crossover section of the preceding weft yarn. For woven materials, the term “crossover distance” as used herein means the distance between weft tapes.

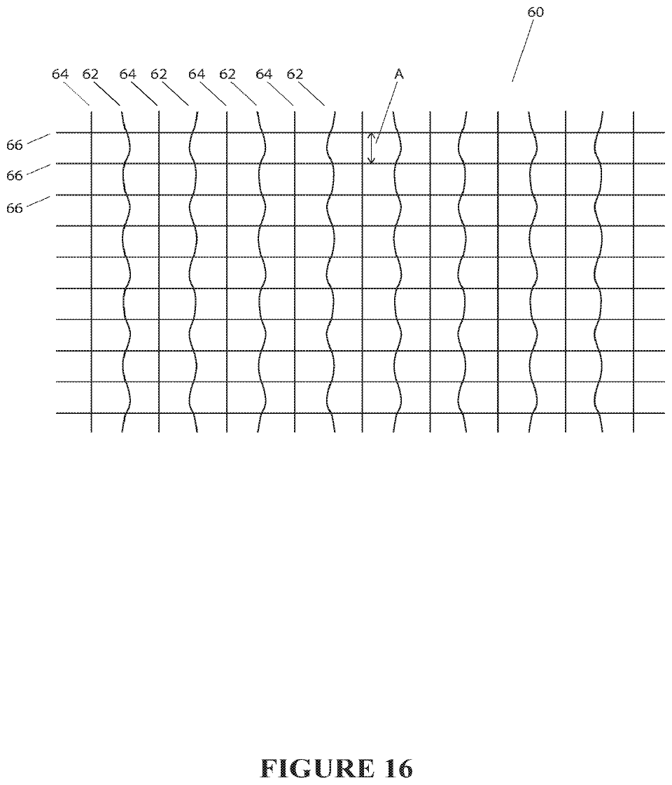

In another embodiment, the crop netting is of plain weave construction comprising warp and weft yarns defining the borders of apertures in the netting, i.e. each aperture may of generally square construction defined on two opposing sides by two adjacent warp yarns, and on the other two opposing sides by adjacent weft yarns. Every other warp yarn may be woven such that the distance measured along every other warp yarn between two weft yarns is longer than the equivalent distance measured along its adjacent warp yarn (see FIG. 16 for example). This may form a construction where each aperture in the netting material is bordered on one side by a section of warp yarn of one length, and on the other side by a section of warp yarn of longer length. Sections of weft yarns forming the other two sides may be of the same length. According to this construction, the longer section of a warp yarn may move under the weight of a hail stone, thereby facilitating the passage of the hail stone through the netting. Such a netting is illustrated in FIG. 16 which illustrates schematically a plain weave material 60 comprised of warp yarns 62, 64 and weft tapes 66. Every second warp yarn 62 is relatively loose compared to its adjacent warp yarn 64 such that when the crop netting is installed under tension in both lateral and longitudinal directions, the sections of warp yarn 62 defining a side of an aperture are still relatively free to move, such as under the weight of a hail stone, and thereby allow passage of that hail stone through the netting. In such a netting the warp yarns 62 comprising sections that are relatively free to move may be longer than, for example, adjacent yarns 64 that do not comprise such sections.

The yarns may be formed from any suitable material, including plastic or polymer materials. Typically, they are extruded from a polymer resin. In particular they may be comprised of thermoplastic polyolefins such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA), thermoplastic polyurethane (TPU), ethylene methyl acrylate (EMA) and elastomers are useful for imparting elasticity and other properties. Polyamides can be used to add strength. Polyesters, polyethylene terephthalate (PET), polymethylmethacrylate (PMMA) and polycarbonate may also be useful. Starch and other plant polymers are useful to increase biodegradability. The polymer or polymer blend may incorporate agents such as one or more pigments, UV stabilisers, or processing aids.

In some embodiments a netting of the invention may be finished with a different structure or a higher density construction at a, or each, lateral edge, for example to include a finished edge, reinforced openings, or other features. In some embodiments the construction at a lateral edge comprises a knitted pillar construction with the pillars in the longitudinal edge region spaced closer together than in the remainder of the netting. In some embodiments, spacing between pillars in the longitudinal edge regions is 1 mm to 6 mm, or 2 mm to 5 mm, or 3 mm to 4 mm.

In some embodiments, the material (both pillar yarns and crossover yarns) may comprise an additive to increase the pliability of the yarns. Additional pliability may be useful to assist in absorption of kinetic energy (and velocity) from hail stones passing through the material, and/or may assist in hail stone passage through the material thereby mitigating hail accumulation on the material. In some embodiments the crossover yarns comprise an additive, and not pillar yarns. In some embodiments some crossover yarns comprise such an additive and others do not (e.g. alternating crossover yarns may include/exclude an additive). The inclusion or exclusion of an additive can be used to provide variation in the properties of the different yarns. The additive may be a rubber modifier, such as POA. The rubber modifier may comprise less than 1% by weight of the yarns to which it is added, or may comprise between 0.1 and 1% by weight of the yarns to which it is added.

In some embodiments the netting may comprise a region of larger apertures. Larger apertures may be useful for assisting in bee passage through a netting or they may be useful to provide a region where hail build up on a netting may pass through a netting. The region of larger apertures may be formed on the same loom as a main body of the netting, or it may be formed separately and then attached to the main body.

In some embodiments, the material may comprise pigment to influence its solar radiation reflection, absorption or transmittance properties, which may be particularly desirable in horticultural applications. In some embodiments the yarns of the material may:
absorb, transmit or reflect more than about 20%, or more than about 40%, or more than about 50%, or more than about 60%, or more than about 70%, on average, of solar radiation across the wavelength range 280 to 400 nm; and
absorb, transmit or reflect more than about 20%, or more than about 40%, or more than about 50%, or more than about 60%, or more than about 70%, on average, on average, of solar radiation across the wavelength range 400 to 700 nm; and either
absorb, transmit or reflect more than about 20%, or more than about 40%, or more than about 50%, or more than about 60%, or more than about 70%, on average, of solar radiation across the wavelength range 700 to 2500 nm; or
absorb, transmit or reflect more than about 20%, or more than about 40%, or more than about 50%, or more than about 60%, or more than about 70%, on average, of solar radiation across wavelength range 700 to 2500 nm.

Such a material may be useful for horticultural applications requiring high UV protection while allowing some visible and infra-red light through, and for hail exclusion, or for wind protection.

In some embodiments at least the yarns of the material may:
absorb more than about 50%, or more than about 70%, or more than about 90% of solar radiation across wavelength range 280 to 2500 nm.

Such a material may be useful for horticultural applications requiring shading from the sun.

In some embodiments the yarns main body of the material may:
absorb more than about 40%, or more than about 50%, or more than about 60%, or more than about 70%, on average, of solar radiation across the wavelength range 280 to 400 nm; and
reflect more than about 40%, or more than about 50%, or more than about 60%, or more than about 70%, on average, of solar radiation across the wavelength range 400 to 700 nm; and either
reflect more than 30% or more than about 50%, or more than about 70%, on average, of solar radiation across the wavelength range 700 to 2500 nm; or
absorb more than about 15%, or more than about 30%, or more than about 50%, on average, of solar radiation across wavelength range 700 to 2500 nm

Such a material may be useful for horticultural applications requiring high UV absorbency and high visible light reflection.

In some embodiments the yarns of the material may:
absorb more than about 50%, or more than about 70%, or more than about 90% of solar radiation across wavelength range 280 to 400 nm; and
transmit more than about 50%, or more than about 60% of solar radiation across the wavelength range 400-2500 nm.

Such a material may be useful for horticultural applications requiring high UV absorbency and high visible light transmission. Such material is also useful as insect, hail, and wind protection.

In some embodiments the yarns of the material may:
reflect more than about 40%, or more than about 60%, or more than about 80% of solar radiation across wavelength range 280 to 2500 nm.

Such a material may be useful for horticultural applications requiring shading from the sun.

In some embodiments at least the main portion of the material may:
transmit more than about 50%, or more than about 60% or more than about 70% of solar radiation across the wavelength range 280 to 2500 nm; and
reflect more than about 10%, or more than about 15% or more than about 20% of solar radiation across the wavelength range 280 to 2500 nm.

Such a material may be useful for horticultural applications requiring high visible light transmission.

In some embodiments the netting material may comprise pillars comprising pillar yarns having different reflective, absorption, or transmission properties, or different thickness, weight or strength properties, than the cross over yarns.

In some embodiments the pillar yarns may comprise different pigment to the crossover yarns. In some embodiments the pillar yarns may have the reflectance, absorbance and/or transmittance properties of any of the materials described above. Where the material comprises more than one pillar yarn per pillar, one or more of the pillar yarns may comprise the reflectance, absorbance and/or transmittance properties of any of the materials described above and the crossover yarns may have different reflectance, absorbance and/or transmittance properties. In other embodiments the crossover yarns may have reflectance, absorbance and/or transmittance properties of any of the materials described above. Where the material comprises more than one crossover yarn on either side of a pillar, one or more of such crossover yarns may have the reflectance, absorbance and/or transmittance properties of the materials described above and the pillar yarns may have different reflectance, absorbance and/or transmittance properties.

In some embodiments the crossover yarns may absorb more than 20%, 30%, 40%, 50%, 60%, 70%, 80% or 90%, on average, of solar radiation across the wavelength range 280 to 400 nm and the pillar yarns may
absorb, transmit or reflect more than about 20%, or more than about 40%, or more than about 50%, or more than about 60%, or more than about 70%, on average, of solar radiation across the wavelength range 280 to 400 nm; and
absorb, transmit or reflect more than about 20%, or more than about 40%, or more than about 50%, or more than about 60%, or more than about 70%, on average, on average, of solar radiation across the wavelength range 400 to 700 nm; and either
absorb, transmit or reflect more than about 20%, or more than about 40%, or more than about 50%, or more than about 60%, or more than about 70%, on average, of solar radiation across the wavelength range 700 to 2500 nm; or
absorb, transmit or reflect more than about 20%, or more than about 40%, or more than about 50%, or more than about 60%, or more than about 70%, on average, of solar radiation across wavelength range 700 to 2500 nm.

In some embodiments the crossover yarns may absorb more than 20%, 30%, 40%, 50%, 60%, 70%, 80% or 90%, on average, of solar radiation across the wavelength range 280 to 400 nm and the pillar yarns may reflect more than about 40% and absorb more than about 5% or solar radiation across wavelength range 700 to 2500 nm.

In some embodiments the material may have a cover factor of 10 to 30%, or 30 to 60%, or 60 to 85%, or 85 to 95%, or 95 to 100%.

In some embodiments the crop material has a length greater than its width. In some embodiments the width is at least 0.5 m, 1.0 m, 1.5 m, 2.0 m, 2.5 m, 3.0 m, 3.5 m, 4.0 m, 4.5 m, 5 m, 6 m, 7 m, 8 m, 9 m, 10 m, 12 m, 14 m, 16 m, 18 m, 20 m, 25 m, or 30 m, and its length is at least 10, 20, 30, 40, 50, 75, 100, 125, 150, 175, 200, 250, 300, 400 or 600 times its width.

In some embodiments the crossover sections differ in length along a crossover yarn. More specifically, some of the crossover sections that make up a crossover yarn may be shorter in length than other crossover sections of the same crossover yarn such that when installed under tension (i.e. tension applied in a direction orthogonal to the length of the pillars and in the plane of the material) the shorter crossover sections bear tension and are held relatively taut while the longer crossover sections bear no or less tension and are not as taut.

Crossover sections along a crossover yarn may be made to differ in length alternatively (i.e. one shorter, next longer, next shorter, next longer, etc) at the time of knitting by adjusting the loom such that tension applied to the crossover yarn in one direction (e.g. left to right) is greater or less than tension applied to the crossover yarn in the other direction (e.g. right to left). For example, this may be achieved by altering the tension applied by a yarn tension control means such as the tension control bar of the loom in a cyclic manner such that the tension varies at a frequency corresponding to the rate that crossover yarns are knotted into pillars. For example, the tension on the crossover yarns may be so altered mechanically (e.g. linked mechanically to the motion of the loom) or electronically (e.g. linked to an electrically powered actuator controlled by operator input or based on electrical sensor information). Alternatively, tension could be controlled at the creel or bobbin. Altering the speed of production/knit may also affect tension. A skilled reader will appreciate how a tension control bar may be modified or retro-fitted such that the tension on it may be altered appropriately. For example, tension variation may be achieved by a rotating cam acting against a spring attached to the tension control bar, the spring being a means to provide tension on the bar. This may change the tension on the spring and thereby affect tension applied to the crossover yarn. As the cam rotates, tension on the spring may change and cause the tension control bar to rise and fall. The pillar yarns may have tension applied to them by a separate tension control bar.

The tension may be controlled electronically. More specifically a controller such as a microprocessor or other computer control system or algorithm may be used to control the tension applied by a yarn tension control means (such as a tension control bar).

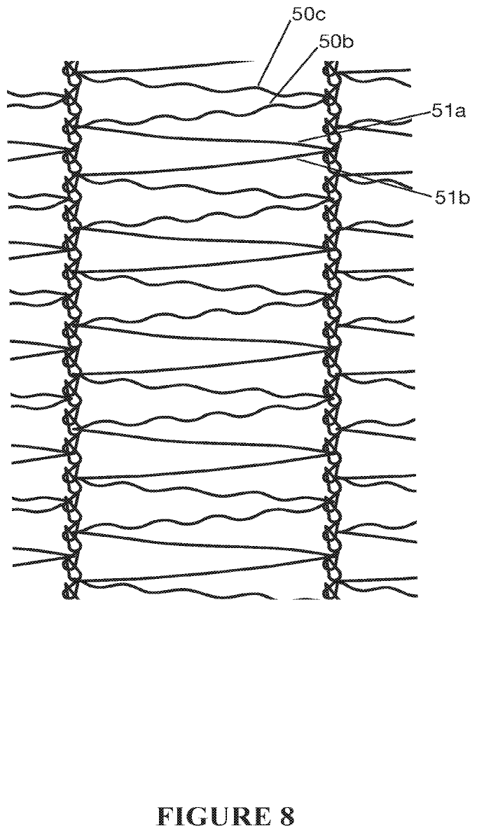

If the tension on the tension control bar of the loom is altered at a frequency that matches the rate that each knot of the crossover yarn is knotted, then a material as illustrated in FIG. 8 may be formed, i.e. alternating longer and shorter crossover sections. If the tension on the tension control bar of the loom is altered at a frequency that is between one and 0.5 times the rate that each knot of the crossover yarn is knotted, then a material more similar to FIG. 8 will be formed, where the crossover sections are in pairs of two longer crossover sections (50a, 50b) followed by two shorter crossover sections (51a, 51b).

A loom may comprise as many tension control bars as suitable for providing the desired differing tensions to different yarns of the material. For example, a loom may comprise one, two, three, four, five or more tension control bars. As mentioned above, the tension on such control bars may be controlled electronically.

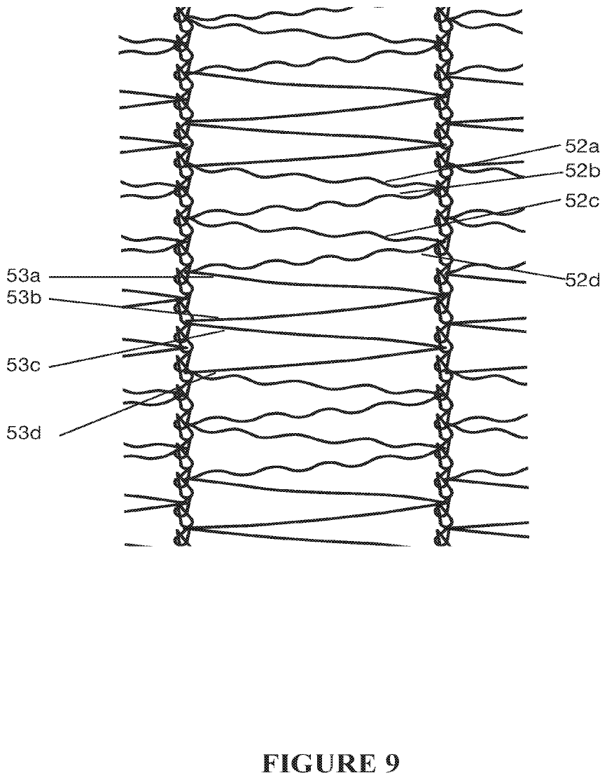

Other frequencies may also be employed such that a material with larger zones of shorter and longer crossover sections may be achieved. For example, in FIG. 9 four longer crossover sections (52a, 52b, 52c, 52d) are followed by four shorter crossover sections (53a, 53b, 53c, 53d). Other combinations of numbers of shorter and longer crossover sections are also envisaged, such as 2 shorter followed by 4 longer.

An alternative way of making crossover sections differ in length along a crossover yarn is to operate a loom with low tension on the crossover yarns. The lower tension means less control over length of crossover yarns between each knot along the length of a crossover yarn, and therefore variability along the length of each crossover yarn. Pillar yarns may also have a lower tension applied to them.

Varying the tension applied to the pillar yarns, either such that different tension is applied to yarns of different pillars, or such that the tension is increased and decreased along the length of a pillar yarn as it is knitted into a pillar, may also be another means to introduce a difference in the length of the crossovers between two adjacent pillars. This may involve setting up two or more tension control bars.

In some embodiments the tightness of knots along the length of a pillar yarn may vary along the length of the yarn to form regions along the length of the pillar yarn having tighter knots and other regions having looser knots, or knots may vary in tightness alternately. Varying the tightness of the knots in this manner may also provide regions of crossover yarns, or individual crossover section, that are relatively taut and other regions, or individual crossover sections, that are loose. Such regions of tight knots and loose knots, or alternating tight and loose knots, may be achieved by varying the tension placed on the pillar yarns by a tension control bar acting on these yarns, or by varying the tension at the creel or bobbin, or by altering speed of production/knit. By altering the frequency of the variation of tension, the regions of tight knots may be short or they may be longer.

In embodiments where some crossover yarns have shorter (or tighter) crossover sections consistently along their length and other crossover yarns have longer (or looser) crossover sections along their length (for example as illustrated in FIG. 12), the difference in length (or tightness) may be achieved by, at the time of knitting or weaving, applying more tension on one crossover yarn than the other.

Embodiments such as those described above with crossover sections that differ in length may result in the accumulation of less hail fall upon an upper surface of a netting because the longer crossover sections have more freedom to move, thereby allowing them to shift under the weight of the hailstones which may assist in the passage of hailstones through the netting. Thus, the netting (including the longer crossover sections) may still absorb the initial kinetic energy (or velocity) of falling hailstones as such hailstones fall upon the netting, but the ability of some of the crossover sections (i.e. the longer ones) to move in response to hailstones that have landed upon the netting means that an aperture immediately beneath a hailstone may change in size or shape in response to the weight of the hailstone and thereby also allow increased passage of hailstones through the netting. This may assist in the mitigation of hail accumulation on an upper surface of the netting.

In some embodiments, the netting is formed on a loom set up to provide differing tension to the pillar yarns compared to the tension applied to the crossover yarns. For example, the loom may employ a different or an additional tension control bar for the pillar yarns such that these may be knitted at a higher tension than the crossover yarns. In some embodiments the tension control bar affecting the tension on the crossover yarns may apply a cyclic variation in tension to the crossover yarns, and the tension control bar affecting tension on the pillar yarns may apply a constant tension.

In some embodiments, a netting of the invention as described above or describe further below may form a region or a series of regions of a larger netting. For example, in a crop netting with a length greater than its width, a netting of the invention as described above may constitute a band extending along the length of the netting, with a different netting construction, for example different aperture shape or size, from the rest of the netting. The band of netting material of the invention may be a single band extending the length, or substantially the length, of the crop netting, or it may be repeated across the width of the crop netting such that the crop netting as a whole comprises a plurality of bands of netting material of the invention extending along its length. Such a netting may be formed on a single loom, or the different sections of material may be formed separately and stitched together.

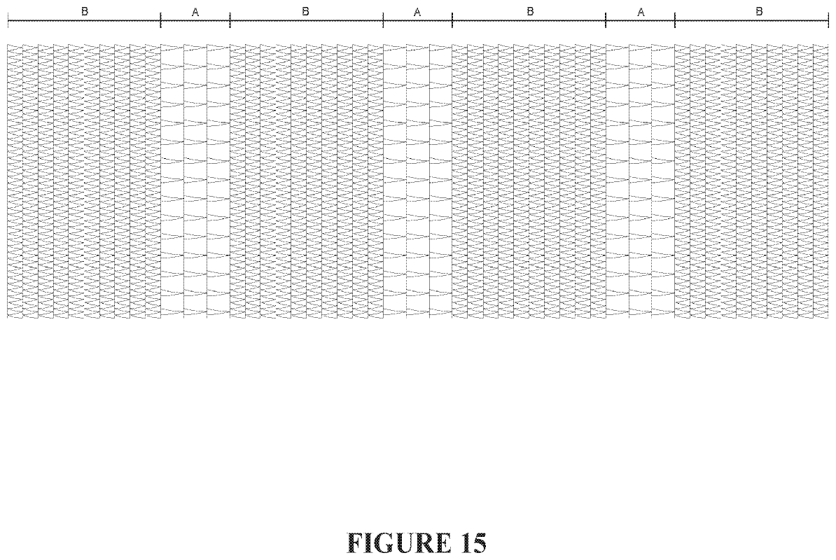

FIG. 15 is a general representation of a crop netting as described immediately above. In FIG. 15, the crop netting comprises repeating bands of netting material of the invention, indicated with an ‘A’, extending the length of a crop netting material and spread across the width of the netting material. The remaining regions, indicated with a ‘B’, are regions of smaller aperture size. Such an arrangement can be beneficial to provide regions of heat release, or passage for bees, or regions that have greater ability to allow passage of hail. Depending on the desired purpose of the purpose of the crop netting, such bands of material may be spaced apart by between 0.5 and 8 m. The width of the bands may be anywhere between about 4 cm to about 2 m, or more. For example, a crop netting may comprise bands of 10 cm width of netting of a structure of the invention separated by regions of 1 m width of netting of a smaller aperture.

The netting generally represented in FIG. 15 may be a pillar knitted fabric with a distance between pillars of the ‘B’ regions being less than the distance between pillars of the ‘A’ regions. For example, the distance between pillars of the ‘B’ regions may be about 8 mm and the distance between pillars of the ‘A’ regions may be about 24 mm.

In some embodiments, the netting generally represented in FIG. 15 may comprise an aperture ratio of apertures in the ‘A’ region compared to apertures in the ‘B’ region, counted along the length of the space between two adjacent pillars in the ‘A’ region compared to the space between two adjacent pillars in the ‘B’ region, of 1:2, or 1:3, or 1:4.

In some embodiments, the netting generally represented in FIG. 15 may comprise yarns of higher denier in the ‘A’ regions, or the yarns in the ‘A’ region may be otherwise reinforced to increase strength (for example, the pillars may include one or more additional pillar yarns, or may be of different make-up such that the yarns have additional strength or stretch to prevent breaking). In some embodiments, the pillar yarns in the ‘A’ regions may be of higher denier than the pillar yarns of the ‘B’ region.

In another aspect the invention provides a crop netting having a length dimension and a width dimension, comprising yarns defining apertures to form said crop netting, said apertures comprising a plurality of sides, each side formed by a yarn section extending generally a length or width dimension, wherein, for at least a first region of said netting, at least 25% of said apertures comprise either:
a yarn section (hereinafter ‘low tension yarn section’) extending in a width dimension that remains slack, or is under no or little tension compared to other yarn sections, when said crop netting is held taut, but not stretched, in a width dimension, and/or
a yarn section (hereinafter also ‘low tension yarn section’) extending in a length dimension that remains slack, or is under no or little tension compared to other yarn sections, when said crop netting is held taut, but not stretched, in a length dimension.

Also described herein is a crop netting having a length dimension and a width dimension, wherein in at least a first region of said netting comprises yarns defining apertures to form said first region, each of said apertures comprising a plurality of sides, each side formed by a yarn section extending generally in said length dimension or said width dimension, wherein at least 25% of said apertures comprise either:
a low tension yarn section extending generally in said width dimension that remains slack, or is under less tension than another yarn section of said aperture also extending generally in said width dimension, when said crop netting is held taut, but not stretched, in said width dimension, and/or
a low tension yarn section extending generally in said length dimension that remains slack, or is under less tension than another yarn section of said aperture also extending generally in said width dimension, when said crop netting is held taut, but not stretched, in said length dimension.

In another aspect the invention provides a crop netting having a length dimension and a width dimension, wherein in at least a first region of said netting comprises yarns defining apertures to form said first region, each of said apertures comprising a plurality of sides, each side formed by a yarn section extending across said length dimension or said width dimension, each yarn section having a length and midpoint thereof halfway along said length, wherein at least 25% of said apertures comprise either:
a first yarn section and a second yarn section both extending across said width dimension, wherein the midpoint of the first yarn section can move a greater distance in a direction orthogonal to said first yarn section than a midpoint of the second yarn section of the same aperture in a direction orthogonal to said second yarn section when each of said midpoints of said yarn sections are placed under the same amount of force back and forth along an axis orthogonal to each of said yarn sections and in the plane of the netting, when said crop netting is held taut, but not stretched, in said width dimension, and/or
a first yarn section and a second yarn section both extending across said length dimension, wherein the midpoint of the first yarn section can move a greater distance in a direction orthogonal to said first yarn section than a midpoint of the second yarn section of the same aperture in a direction orthogonal to said second yarn section when each of said midpoints of said yarn sections are placed under the same amount of force back and forth along an axis orthogonal to each of said yarn sections and in the plane of the netting, when said crop netting is held taut, but not stretched, in said length dimension.

In some embodiments the netting is a knitted netting, or is a woven netting, or is a nonwoven netting.

In some embodiments, for said first region, at least 35%, or at least 45%, or at least 55%, or at least 65%, or at least 75%, or at least 85%, or at least 95%, or all, of said apertures comprise either:
a yarn section extending in a width dimension that remains slack, or is under no or little tension compared to other yarn sections, when said crop netting is held taut, but not stretched, in a width dimension, and/or
a yarn section extending in a length dimension that remains slack, or is under no or little tension compared to other yarn sections, when said crop netting is held taut, but not stretched, in a length dimension.

In some embodiments the first region is a main body region.

In some embodiments the first region comprises more than about 30%, or more than about 40%, or more than about 50%, or more than about 60%, or more than about 70%, or more than about 80%, or more than about 90% of the of the crop netting, or comprises all of the crop netting.

In some embodiments the main body region comprises more than about 30%, or more than about 40%, or more than about 50%, or more than about 60%, or more than about 70%, or more than about 80%, or more than about 90%, of the width of the crop netting.

In some embodiments the first region comprises less than about 50% of the crop netting, or less than about 40% of the crop netting, or less than about 30% of the crop netting, or less than about 20% of the crop netting, or less than about 10%, of the crop netting.

In some embodiments the first region comprises less than about 50%, or less than about 40%, or less than about 30%, or less than about 20%, or less than about 10%, of the width of the crop netting.

In some embodiments the first region comprises a band or bands extending lengthwise along, or substantially the length of, the crop netting.

In some embodiments each of the bands has a width of between 4 cm and 2.0 m, or between 8 cm and 2.0 m, or between 10 cm and 2.0 m, or between 15 cm and 2.0 m, or between 20 cm and 2.0 m, or between 40 cm and 2.0 m, or between 4 cm and 1.0 m, or between 8 cm and 1.0 m, or between 10 cm and 1.0 m, or between 15 cm and 1.0 m, or between 20 cm and 1.0 m, or between 40 cm and 1.0 m, or between 4 cm and 0.5 m or between 0.5 m to 1.0 m, or between 1.0 m and 1.5 m, or between 1.5 m to 2.0 m.

In some embodiments the bands are separated by at least 0.5 m, or at least 1 m, or at least 1.5 m, or at least 2.0 m, or at least 2.5 m, or at least 3 m, or at least 4 m, or at least 5 m, or at least 6 m, or at least 7 m, or at least 8 m, of width of crop netting.

In some embodiments the first region is at least 0.5 m, or at least 1 m, or at least 2 m, or at least 10 m, or at least 20 m, or at least 30 m, or at least 50 m, or at least 100 m, or at least 150 m, or at least 300 m long.

In some embodiments the first region is of a pillar knitted construction.

In some embodiments the first region is of plain weave construction.

In some embodiments the first region is of leno-weave construction.

In some embodiments the low tension yarn section is of sufficient length such that said apertures comprising a low tension yarn section can increase in size by at least 3%, or at least 5%, or at least 8%, or at least 10%, or at least 12%, at least 15%, or at least 20%, or at least 40%, or at least 50%, or at least 60%, or at least 70%, or at least 80%, or at least 90%, or at least 100%, or at least 110%, or at least 120%, or at least 130%, by rearranging the lie of the low tension yarn when said crop netting is held taut, but not stretched, in the direction in which the yarn section generally extends, or is held taut, but not stretched, in both lengthwise and widthwise directions.

The distance a midpoint of a crossover yarn section or yarn section of an aperture of a crop netting may move under a particular force may be measured in the following manner:
Arrange the crop netting such that it is held taut in the length and width dimensions
Fix/hold the ends of the crossover yarn section or yarn section in place such that they cannot move
Apply force to the midpoint of the crossover yarn section or yarn section in one direction along a specified axis in the plane of the netting, and then apply the same amount of force in the other direction on said same axis. The force should be just sufficient to make the crossover section taut.
Measure the distance between the limits that the midpoint of the yarn section may move along said axis.

A netting can be considered to be held taut in length and width dimensions when it has been fixed in a circular embroidery hoop of 22 cm internal diameter, lying in a horizontal plane, said netting fixed such that a downward force applied to the centre of the netting as it lies in the hoop of approximately 2N results in the netting moving downwards about 2 cm.

In some embodiments, the distance measured is a distance that a crossover yarn section or a yarn section may move along the specified axis in a direction outward from the relevant aperture. The distance may be measured from the natural lie of the crossover yarn section or yarn section.

### Illustration of Netting Installed

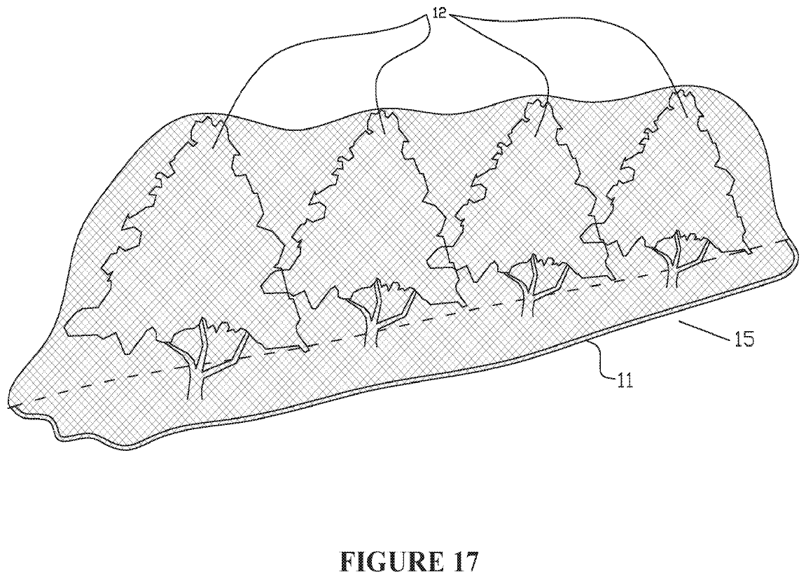

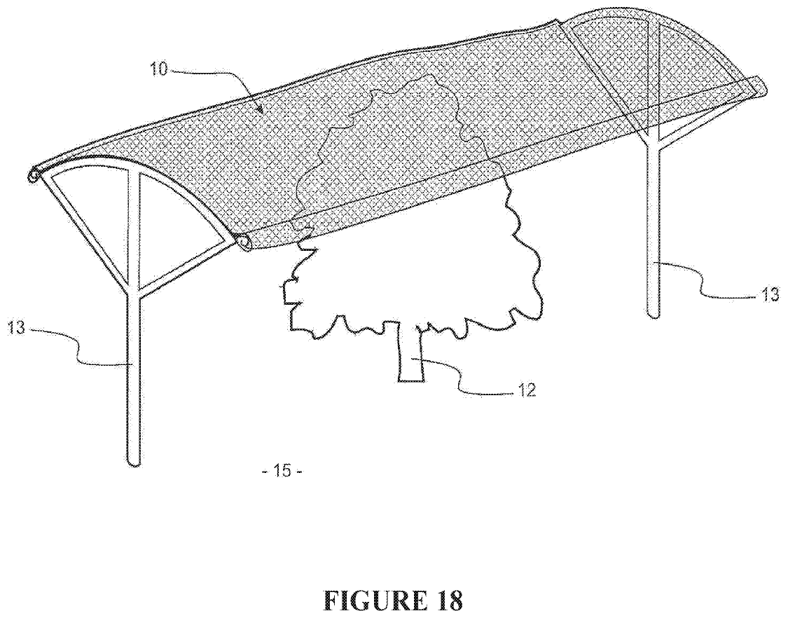

A further aspect of the invention is now described. Typically and as illustrated in FIGS. 17 and 18, netting may be supported over the plant(s) and/or as a vertical and/or angled wall or walls near the plant(s), by for example cables or wires between posts positioned along the rows of plants in a garden, field crop, orchard or vineyard, or is draped over the plant(s), or is retained over the plant(s) by a supporting structure such as by wires above the plant(s) extending between support poles. Netting may be placed near plants to protect for example annual plants, perennial plants, fruit trees, or grape vines, vegetable plants, from birds or insects.

Referring to FIG. 17, a length of crop protection netting 10 of the invention is shown placed over a row of fruit trees 12. Or alternatively the netting sits on top of the tree tops and is joined between the rows of the trees, to give a continuous net over the trees and not having to go down the sides of the trees, at least not the trees not on the edge of the block. The netting may be manufactured in a length and width to suit typical applications or a range of lengths and/or widths. Typically the width of the netting is between about 2 and 30 metres and the length of the netting is longer. Typically the netting is large enough to extend over an entire plant or row of plants as shown, and be secured, fastened or anchored at or toward the peripheral edges 11 of the netting with stakes, pegs, soil or other fixing devices to the ground 15 surrounding the periphery of the plant or plants. Alternatively, the edges 11 of the netting may drape onto the ground and need not necessarily be secured in any way other than under its own weight. As shown in FIG. 17, the netting 10 is draped over the trees such that it is in contact with and supported in place by the trees it covers. The netting may also be arranged such that its peripheral edges 11 extend at least some way toward the ground 15, or fully to the ground, if more or full coverage is desired.

FIG. 18 shows an alternative installation of crop protection netting of the invention as a canopy extending over the top of a fruit tree 12, and this installation may be applied over/along a row of trees also. The canopy installation comprises a supporting structure 13 or framework that supports or suspends the netting 10 over the fruit trees. The canopy could be placed on an angle over the trees, or be arranged in a substantially flat horizontal plane. The supporting structure 13 may comprise one or more upright posts alone or in combination with supporting wire or wires or other cross-members extending between the posts.

Optionally edge portions (not shown) of the netting may be reinforced or formed with different material to assist in fixing the netting to the ground. As shown, the entire netting or majority of the netting if the edges are reinforced is formed from a knitted mesh construction shown.

### Netting With Parallel Secondary Yarns Forming Secondary Apertures

Other embodiments of netting material of the invention, which are typically also used as described above with reference to FIGS. 17 and 18, comprise a plurality of primary yarns knitted to form a mesh construction having an arrangement of primary apertures defined by yarn intersections and yarn connecting portions between yarn intersections, and a plurality of secondary yarns, the secondary yarns crossing over the primary apertures to form secondary apertures within the primary apertures. The netting may be knitted from a synthetic yarn, for example a monofilament.

The netting is typically machine-knitted on a warp knitting machine or other knitting-machine. The netting comprises an array of mesh apertures.

The netting may comprise primary apertures through the material of widest dimension about 30 mm. In other embodiments netting of the invention may comprise primary apertures through the material of widest dimension about 20 mm. In some embodiments netting of the invention may comprise primary apertures through the material of widest dimension in the range 10-30 mm.

The mesh apertures (i.e. primary apertures) may have a size, as measured around the perimeter of the aperture, of 20 to 160 mm, or 20 to 100, or 30 to 95 mm, or 40 to 90 mm, or 50 to 85 mm.

In some embodiments the primary apertures have an aperture size of about 6 mm to about 72 mm, or about 8 mm to about 64 mm, or about 10 mm to about 56 mm, or about 12 mm to about 48 mm, or about 16 mm to about 40 mm, or about 16 mm to about 32 mm, or about 24 mm+/−6 mm.

The mesh apertures may have four sides. In the four-sided form of the mesh apertures, the shape of the apertures may be substantially square, rectangular or any other shape. It will also be appreciated that the mesh apertures may be knitted to have more than four sides, and with intersections in alternative forms of the knitted mesh construction to create more complex mesh aperture shapes, for example but not limited to hexagonal shaped apertures.

The netting may have size dimensions as already previously described.

In some embodiments netting of the invention may comprise primary apertures (i.e. when considered excluding any lay-in) through the material of widest dimension about 40 mm. In other embodiments netting of the invention may comprise apertures through the material of widest dimension about 20 mm. In some embodiments netting of the invention may comprise apertures through the material of widest dimension in the range 10-40 mm.

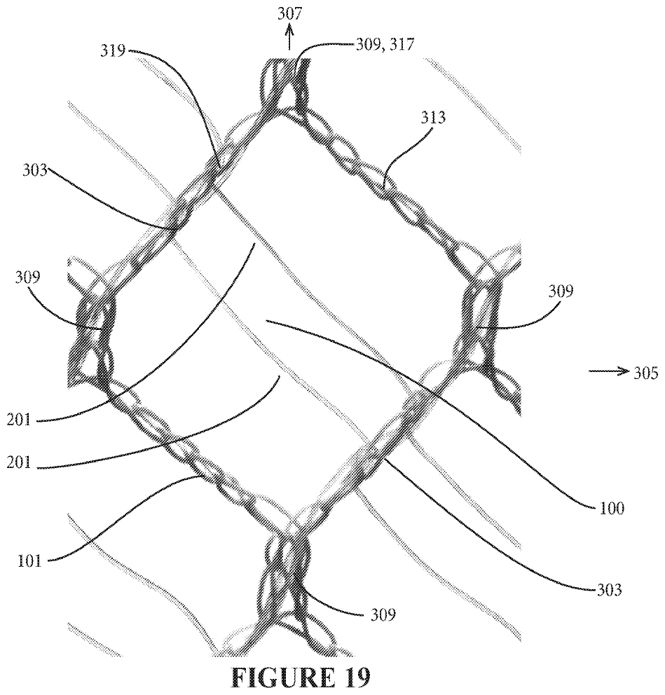

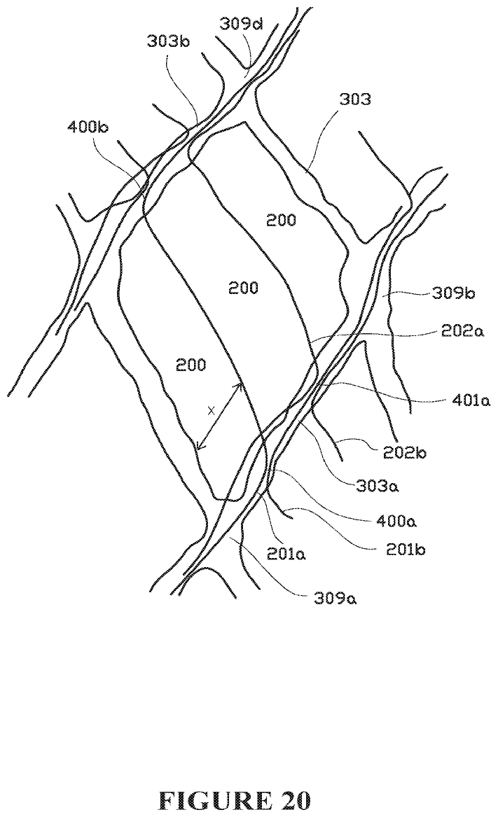

The netting is typically machine-knitted on a warp knitting machine or other knitting-machine. The netting comprises an array of mesh apertures. The mesh apertures of a netting material according to one embodiment are shaped as seen in FIG. 19 and FIG. 20, comprising four sides or yarn connecting portions and four yarn intersection points and are substantially uniform in shape and size. The orientation of the mesh apertures relative to the length direction 307 and width direction 305 of the netting need not be as shown in FIG. 19. FIGS. 19 and 20 would typically be replicated throughout the major expanse of the netting. The netting may be finished with a different structure at each lateral edge, for example to include a finished edge, reinforced openings or other features.

With reference to FIG. 19, the mesh aperture 100 is defined by yarn connecting portions 303. In the illustrated form four yarn connecting portions are arranged to form sides of a four sided aperture, which is aligned at generally 45 degrees to the length dimension 307 and width dimension 305 of the netting. In some embodiments the aperture may be a square or a diamond shape. The connecting portions 303 meet at yarn intersections 309.

In a netting material according to some embodiments of the present invention, the netting material comprises primary yarns 101 and secondary yarns 201. In some embodiments, each yarn 101, 201 in the netting generally proceeds in the length direction 307. The primary yarns are knitted together to form a mesh construction comprising primary apertures 100. In some embodiments, the primary yarns extend lengthwise, adjacent primary yarns being knitted or knotted or looped together at the yarn intersections 309. The primary yarns 101 may extend along an alternating sequence of connecting portions 303 and intersections 309. The primary yarns follow a path that is knitted, knotted or looped along each yarn connecting portion 303 defining the primary aperture. In the illustrated embodiment, two adjacent primary yarns are knitted, knotted or looped together at each intersection point 309. In some embodiments the netting material comprises a plurality of primary yarns each extending along a length of the netting in an approximate zig-zag path with alternating yarn intersections and connecting yarn portions, with adjacent primary yarns knitted, knotted or looped together at the yarn intersections. For example, yarns 313 and 319 are knitted and looped together at the intersection 317. The netting may comprise rows of yarn intersections 309, said rows extending across either the width of the material or along the length of netting material, the yarn intersections of each row of yarn intersections 309 being staggered or offset with respect to its adjacent row of yarn intersections. Put another way, the netting comprises rows of apertures extending across either the width of the material or along the length of netting material, the apertures or each row offset compared to its adjacent row (for example, the rows may be offset as may be formed in a diamond or hexagonal knit pattern, rather than stacked as they may be in a square net pattern).

In a netting material according to some embodiments of the present invention, each secondary yarn is not knotted or looped in the yarn connecting portion. The primary yarn 101 is knitted, knotted or looped around the secondary yarn 201 in the yarn connecting portion. In other words, a secondary yarn 201 weaves back and forth or is threaded through knitted primary yarn 101 along the yarn connecting portion 303. Secondary yarn 201 is not knitted, knotted or looped, but is retained by the knitting and looping of primary yarn 101, which passes around secondary yarn 201. The secondary yarn 201 is retained by the knitting or knotting or looping of the primary yarn without being knitted, knotted or looped in the yarn connecting portion 303.

Each secondary yarn passes part way along a yarn connecting portion 303 and then extends from the yarn connecting portion 303 to cross over a primary aperture 100 to another yarn connecting portion defining that primary aperture 100. That is, the secondary yarn extends across the primary aperture 100 between a pair of yarn connecting portions. As at least one secondary yarn crosses between each opposing pair of yarn connecting portions of an aperture 100. Optionally, two, three, four, five, six, seven, eight or more secondary yarns cross between each opposing pair of yarn connecting portions. The secondary yarns may cross the aperture such that they are substantially parallel to each other across the aperture. The secondary yarns have been illustrated as crossing from left to right in FIG. 19. The secondary yarns could similarly cross from right to left.

The secondary yarns may be spaced evenly across the aperture (i.e. more so than illustrated in FIG. 19), such that all secondary apertures have the same width. In some embodiments, 4 or 6 secondary yarns cross the primary aperture and are evenly spread across the width of the primary aperture.

Nettings comprising a primary aperture divided by one or more secondary yarns are known in the prior art. Such prior art nettings employ secondary yarns that orthogonally cross each other in the primary aperture. A disadvantage of such an arrangement is that, when hail falls upon the netting, the secondary yarns cannot move sufficiently to enable the size of the secondary apertures (i.e. the apertures created within the primary aperture by division of the primary aperture by the secondary yarns) to increase and thereby allow hail passage. In comparison, the parallel secondary yarns of the netting disclosed herein may much more readily part under weight of hail, or under hail strike. More specifically, kinetic energy (or velocity) of a hail stone may be at least partially absorbed by the netting upon the hail stone hitting the netting disclosed herein and then the parallel secondary yarns may move apart under either the weight or kinetic energy of the hail stone to allow hail stone passage through the netting, thereby allowing hail to pass through the netting but at a velocity that may be sufficiently low to avoid or mitigate damage to fruit growing beneath.

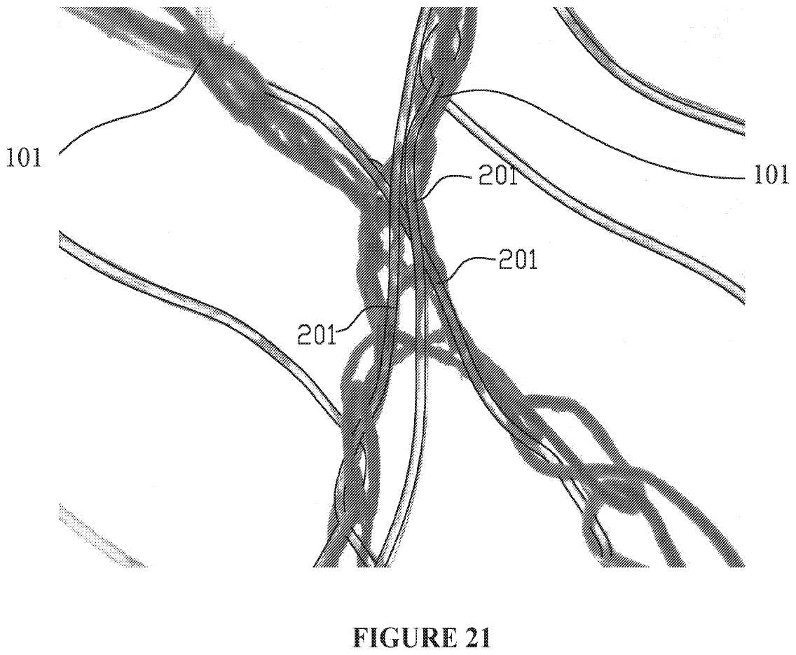

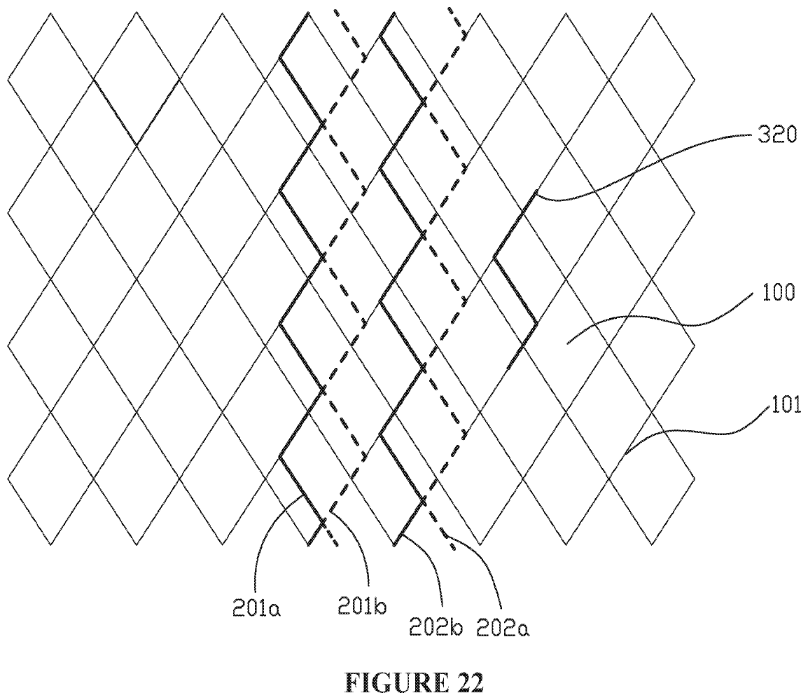

In some embodiments the netting material comprises a plurality of secondary yarns each of which extends along a length of the netting material in an approximate zig-zag path. For example, each secondary yarn extends along the length of the netting material in an approximate zig-zag path and has a zig-zag pitch and amplitude the same as a zig-zag pitch and amplitude of the primary yarns. The zig-zag path of each secondary yarn is offset along a connecting yarn portion of the mesh construction by a distance, for example distance “x” illustrated in FIG. 20. Thus each secondary yarn extending in a zig-zag pattern has a repeating portion (for example portion 320 indicated in FIG. 22) that extends from an intersection point 309, partway along a yarn connecting portion 303, across a primary aperture 100 to the yarn connection portion 303 on the opposite side of the aperture, and then partway along the yarn connecting portion 303 on the opposite side of the primary aperture to the next yarn intersection 309 along the netting material. In some embodiments the secondary yarn is not knotted or looped in the yarn intersections of the netting material. Thus the secondary yarns extend along the netting material in a zig-zag path along yarn connecting portions and through or over yarn intersections and across primary apertures without being knitted, knotted or looped in the netting and is retained by the knitted, knotted or looped primary yarns in the yarn connecting portions and/or intersections of the netting. For example, each secondary yarn passes through or over a yarn intersection point 309 without a substantial change in direction. An exemplary intersection 309 is illustrated in greater detail in FIG. 21.

In some embodiments the secondary yarns may cross over primary apertures without passing along a yarn connection portion. For example each secondary yarn may pass orthogonally through a yarn connecting portion without passing along the yarn connecting portion.

As illustrated in FIG. 20 where the knitted primary yarns are shown in outline to aid with clarity in the path of the secondary yarns, in some embodiments, a secondary yarn, for example 201a, extends part way along a yarn connecting portion 303a from a yarn intersection 309a at a first end of the yarn connecting portion to a separation point 400a. The yarn diverges from or extends from the separation point 400a to pass across the primary aperture 100. An adjacent secondary yarn 201b enters the same yarn connecting portion 303a at or near to the separation point 400a and extends along the remainder of the yarn connecting portion 303a from the separation point 400a to the yarn intersection 309b at the second end of the yarn connecting portion. The secondary yarn 201a enters the yarn connecting portion 303b at the opposite side of the primary aperture 100 and extends along that yarn connecting portion from a separation point 400b to the yarn intersection 309d at the second end of the yarn connecting portion 303b. The adjacent secondary yarn 201b passes through or over the yarn intersection 309b at the second end of the yarn connecting portion 303a and into the yarn connecting portion of an adjacent aperture. Thus each yarn connecting portion comprises at least two adjacent secondary yarns, by example 201a and 201b. The adjacent secondary yarns for example 201a, 201b are illustrated in FIG. 20 to not overlap to add clarity in illustrating the paths of the secondary yarns in the netting material. However, in some embodiments the adjacent secondary yarns 201a, 201b may overlap at the separation point 400a. Preferably the adjacent secondary yarns 201a and 201b are not looped or intertwined together at the separation point 400a.

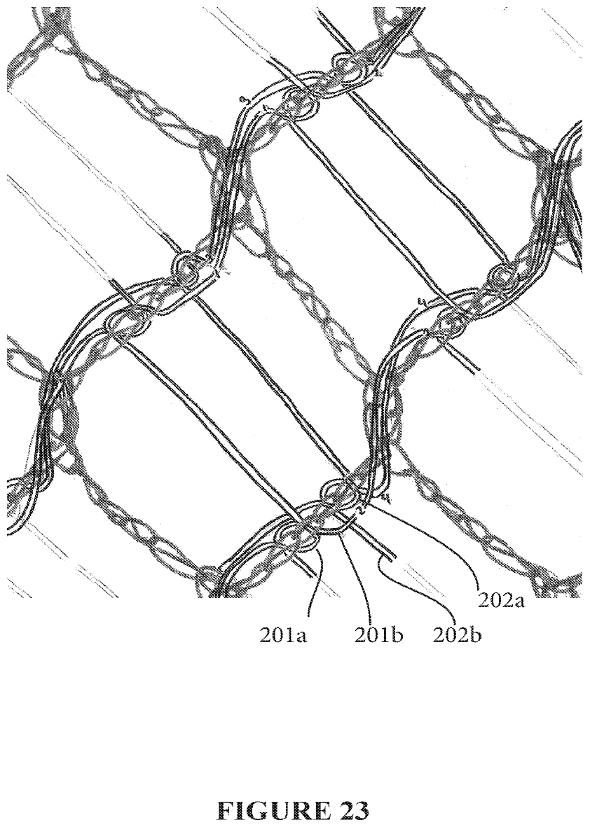

The zig-zag path of each secondary yarn may be offset along a connecting yarn portion of the mesh construction by a distance equal to a size of a secondary aperture. In the illustrated embodiment there are two pairs of adjacent secondary yarns that extend partially along the yarn connection portions of a primary aperture 100; for example secondary yarns 201a and 201b, 202a and 202b, as illustrated in FIG. 20. These four secondary yarns that are shown with reference to a single primary aperture in FIG. 20 are shown spaced apart in FIG. 22 to illustrate the zig-zag path of the secondary yarns through the netting material (yarns 201b and 202a have been shown in dashed form to distinguish them from yarns 201a and 202b). FIG. 23 provides a further illustration of a netting material according to some embodiments of the present invention with four secondary yarns 201a and 201b, 202a and 202b, shown threaded through the knitted primary yarns 101. In FIG. 23, the bending or curve of the secondary yarns as they change direction through the knit of the primary yarns is exaggerated for ease of displaying the path of the secondary yarns.

In the illustrated embodiment, connecting yarn portions 303 may comprise one pair of secondary yarns, for example secondary yarns 201a and 202a in yarn connecting portion 303a. In such yarn connecting portions the pair of secondary yarns pass part way along the connecting yarn portion and extend from the connecting yarn portion to cross over the primary aperture 100 in a spaced apart relation to a connecting yarn portion on an opposite side of the primary aperture to define three generally rectangular primary apertures within each primary aperture.

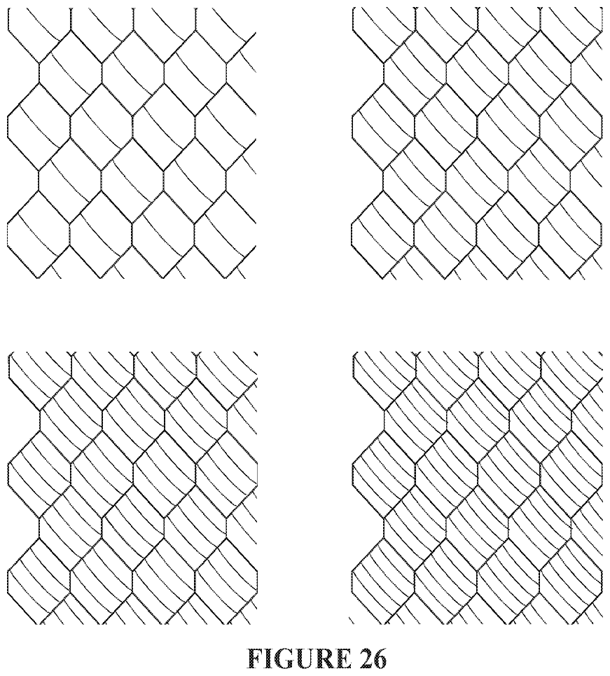

In some embodiments, connecting yarn portions 303 may comprise more than two secondary yarns each of which extend partway along the yarn connecting portion and extend across the primary aperture in a spaced apart relation. For example, in one embodiment connecting yarn portions may comprise three secondary yarns 200 extending partway along the connecting yarn portion 303 and across a primary aperture 100 in a spaced apart relation to the connecting yarn portion on the opposite side of the primary aperture to define four generally rectangular secondary apertures within the primary aperture. Alternatively, four secondary yarns may extend across the primary aperture in a spaced apart relation to create five generally rectangular shaped apertures, or five secondary yarns to create six secondary apertures and so forth. For example, as schematically illustrated in FIG. 26.

Each primary aperture may be divided approximately equally by the secondary yarns, for example into approximately similar dimensioned rectangles sitting side by side. In practice, due to movement of the yarns within the netting and the yarns not being tightly retained or knotted in the netting between intersections and separation points the sizes of the secondary apertures vary such that the apertures are not necessarily equal size. Thus, it is to be understood that in this specification and claims, when it is stated that secondary apertures are of an equal size, such statements refer to a nominal netting pattern rather than a specific netting example where the apertures size and shape may be pulled out of nominal size and/or shape.

The netting is stretchable or extendible in both the width axis or direction indicated by arrow 305 and the length axis or direction indicated by arrow 307 in FIG. 19 which is typically the machine or manufacturing direction.

In the illustrated embodiment the mesh size of the equi-length four sided mesh apertures is defined by the length of the sides 303 between the intersections 309, measured when the netting is in a taut but non-stretched state in both length and width directions. In some embodiments the length of each side may be in the range of approximately 3 mm to 30 mm or 20 mm.

The primary and secondary yarns are typically monofilament yarns of any suitable material as previously mentioned. As for other embodiments described herein, typically the yarns are may be extruded from a polymer resin. Each yarn may be single monofilaments, or alternatively may comprise twin or multiple monofilaments. The monofilament yarns may be circular in cross-section or otherwise shaped. For circular monofilament yarns, the yarn preferably has a diameter in the range of approximately 0.1 mm to 1 mm, even more preferably 0.2 mm to 0.8 mm, and even more preferably 0.2 mm to 0.4 mm, and more preferably 0.15 to 0.3 mm and most preferably 0.15 mm to 0.25 mm. In denier (grams per 9000 meters of the yarn) the yarn is preferably in the range of approximately 50 to 1000 denier, more preferably 50 to 700 denier, even more preferably 100 to 500 denier, even more preferably 100 to 300 denier, even more preferably 150 to 250 denier or most preferably 200 to 300 denier. The monofilament yarn may be stretchable or non-stretchable in length, and may be elastic or non-elastic depending on requirements.

The netting may be relatively lightweight. The weight of the netting may be in the range of approximately 20 to 200 grams per m², or 25 to 150 grams per m², or 30 to 100 grams per m², or 40 to 80 grams per m².

The crop protection netting may have a cover factor (as herein defined) of less than 35%, less than 30%, less than 20%, less than 10%, or less than 5%.

In some embodiments the width of the netting is substantially uniform along the length of the netting.

In some embodiments the mesh size is in the range of approximately 3 mm to 30 mm, 3 mm to 20 mm, or 3 mm to 10 mm.

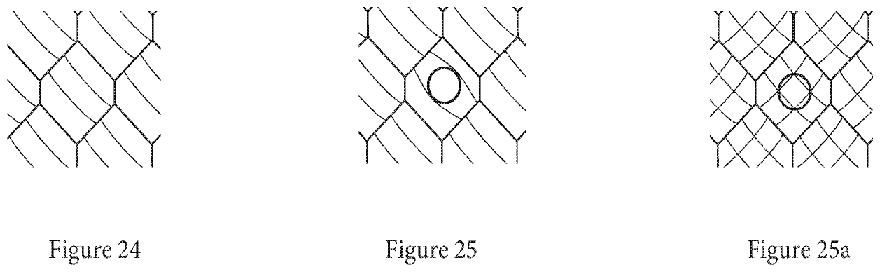

FIG. 24 is a schematic illustration of a netting as illustrated in FIG. 19, without a hailstone. FIG. 25 is also schematic illustration of the netting of FIG. 19 and shows secondary yarns moving under the weight of a hailstone and allowing passage of the hailstone through the netting.

FIG. 25a is a schematic illustration of a prior art netting similar to the netting of FIG. 24, but which includes pairs secondary yarns crossing each primary aperture orthogonally to each other, and illustrating a hailstone sitting on the upper side of the netting. The secondary yarns of such a netting require considerably more force to shape around the hailstone, and as a result, rather than passing through the netting as illustrated in FIG. 25, the hailstone sits atop it.

Having secondary yarns aligned in one direction across an aperture, rather than crossing each other, may also assist in hail travelling across a netting. For example, when a netting is on an incline to horizontal, either due to its installation or as a result of hail accumulating at a sag point, hail may more readily roll down the incline of a netting with parallel secondary yarns across a primary aperture than it would if those secondary yarns were crossed with other secondary yarns. This can be advantageous in that it enables hail to be more readily shed from the upper surface of a netting, or more readily directed to a drain feature in the netting (i.e. such as a region with large (e.g. aperture size of 12 mm or more) apertures).

In some embodiments the primary and secondary yarns are double, triple, or multifilament yarns or are monofilament yarns. In one form the primary and secondary yarns are monofilament yarns. Preferably, the monofilament has a substantially circular cross-section. More preferably the monofilament has diameter in the range of approximately 0.1 mm to 1 mm, even more preferably 0.2 mm to 0.8 mm, and even more preferably 0.2 mm to 0.4 mm, and more preferably 0.2 to 0.3 mm and most preferably 0.15 mm to 0.25 mm In denier, the monofilament yarn is preferably in the range of approximately 50 to 1000 denier, more preferably 50 to 700 denier, even more preferably 100 to 500 denier, even more preferably 100 to 300 denier, even more preferably 150 to 250 denier or even more preferably 200 to 300 denier. In some embodiments the primary yarn is 500 denier and the secondary yarn is 250 denier. In some embodiments the primary yarn is 250 denier and the secondary yarn is 500 denier.

In some embodiments the primary and/or secondary yarns may be tapes. The tapes may be 1 mm to 5 mm, or 2 mm to 3 mm, wide. They may have a mass of 500 to 2500 denier, or 800 to 1200 denier. They may have a thickness of 0.04 to 0.08 mm.

Typically the netting is machine-knitted for example on a warp knitting machine or a weft insertion warp knitting machine.

In some embodiments the weight of the netting is in the range of approximately 20 to 200 grams per m², or 25 to 150 grams per m², or 30 to 100 grams per m², or 40 to 80 grams per m².

Other features, such as specific solar radiation reflectivity, transmission and or absorbance, of the netting and or of primary yarns versus secondary yarns of the netting may be incorporated into at least some embodiments of the nettings of the invention. Such features are more fully described in our international patent application PCT/NZ2015/050012 (WO 2015/122783) filed 11 Feb. 2015, the contents of which is incorporated in its entirety herein by reference.

Netting with Secondary Yarns Forming Secondary Apertures—Secondary Yarns in One Direction Crossing All Above, or All Below, Secondary Yarns in another Direction

Applicant's PCT patent application number PCT/NZ2015/050012 (WO 2015/122783) includes a section entitled “Netting With Secondary Yarns Forming Secondary Apertures”, the contents of which are incorporated herein by reference. Applicant has found that nettings disclosed in that section can be inventively improved by arranging secondary yarns such that where secondary yarns intersect, secondary yarns crossing an aperture in one general direction cross either all above or all below secondary yarns crossing the same aperture in another direction.

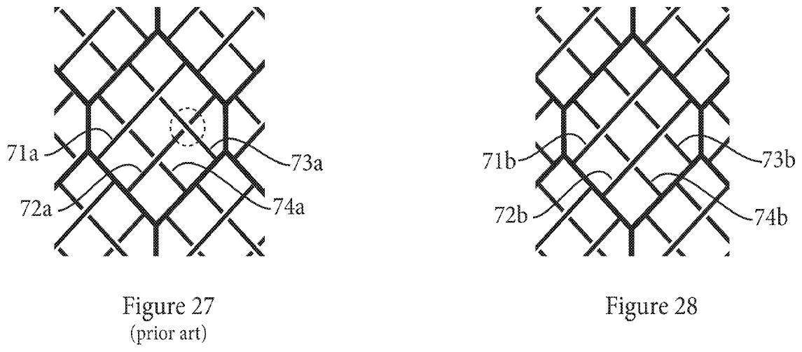

More specifically, with reference to FIG. 28, secondary yarns 71b and 72b cross the primary aperture (illustrated in bolder lines) of the netting from the lower left of the illustrated primary aperture to the upper right of the illustrated primary aperture. Both secondary yarns 71b and 72b are illustrated crossing above secondary yarns 73b and 74b which cross from the bottom right of the illustrated primary aperture to the top left. In comparison, FIG. 27, which illustrates a prior art netting, secondary yarn 72a crosses under secondary yarn 73a (the crossing point illustrated with a dashed circle), such that the secondary yarns are interlaced within the primary aperture. The applicant has found that an arrangement of secondary yarns where all secondary yarns crossing an aperture in one direction are either above or below all secondary yarns crossing an aperture in another direction provides a netting that can more readily facilitate passage of hail, i.e. after absorbing some of the initial kinetic energy (or velocity) of a falling hailstone as already previously discussed. More specifically, because the secondary yarns crossing the apertures of the netting illustrated in FIG. 28 are not interlaced or interwoven, they have a greater ability to spread apart or shape around a hailstone thereby assisting in its passage through the netting. In comparison, in a netting according to FIG. 27 the interwoven or interlaced secondary yarns are relatively more fixed in place because of the interweaving/interlacing, and therefore cannot as readily shift to allow hail passage.

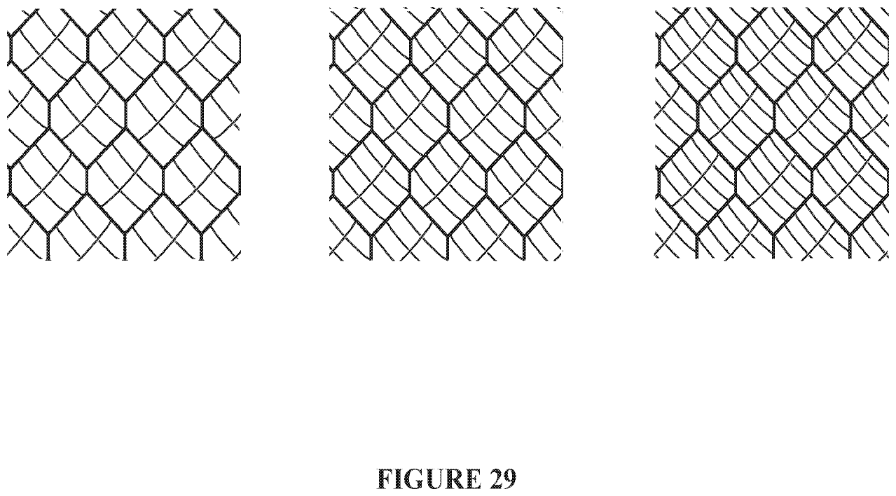

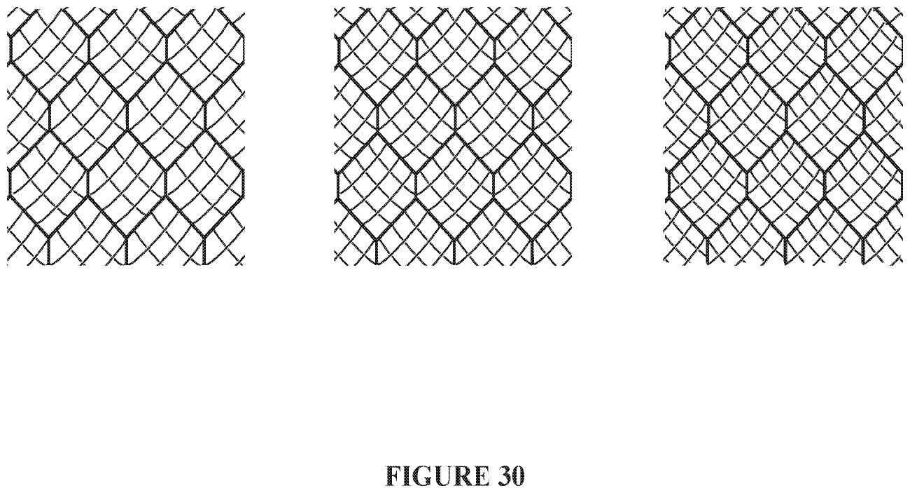

FIGS. 29 and 30 illustrate other embodiments comprising secondary yarns crossing an aperture in one direction all either above or below secondary yarns crossing the same aperture in another direction. Similar to already discussed above, such arrangement can facilitate passage of hail due the increase ability of the secondary yarns to shift compared to interwoven crossovers.

Accordingly, in another aspect the present invention provides a crop netting comprising a first region comprising:
a plurality of primary yarns knitted to form a mesh construction having an arrangement of primary apertures defined by yarn intersections and yarn connecting portions between yarn intersections, and
a plurality of secondary yarns, said plurality of secondary yarns crossing over said primary apertures to form secondary apertures within said primary apertures, and
wherein said plurality of secondary yarns comprise first direction secondary yarns, at least two crossing each aperture, which cross from the same one side of each primary aperture to an opposing side of the same primary aperture; and
wherein said plurality of secondary yarns also comprise intersecting secondary yarns that cross said first direction secondary yarns within said primary apertures; and
wherein within said primary apertures said intersecting secondary yarns cross either all under, or all over, said first direction secondary yarns.

In a further aspect the present invention provides a crop netting comprising a first region comprising:
a plurality of primary yarns knitted to form a mesh construction having an arrangement of primary apertures defined by yarn intersections and yarn connecting portions between yarn intersections, and
a plurality of secondary yarns, said plurality of secondary yarns crossing over said primary apertures to form secondary apertures within said primary apertures, and
wherein said plurality of secondary yarns comprise substantially parallel secondary yarns which are substantially parallel to each other within said primary apertures; and
wherein said plurality of secondary yarns also comprise intersecting secondary yarns that cross said substantially parallel secondary yarns within said primary apertures; and
wherein within said primary apertures said intersecting secondary yarns cross either under, or cross over, said at substantially parallel secondary yarns.

The term “substantially parallel” as used herein encompasses secondary yarns that cross from one side of an aperture to an opposing side of the same aperture.

In some embodiments the intersecting secondary yarn crosses the first direction secondary yarns at approximately 90° to the first direction secondary yarns. In other embodiments the intersecting secondary yarn crosses the first direction secondary yarns at between about 30 to 150° to the first direction secondary yarns, or about 60 to 120°, or about 80 to 100°.

An advantage of the invention, at least in the aspects or embodiments directed to a pillar knitted fabric having a wide pillar spacing, is that the crossover yarns of a pillar knitted fabric with wide pillar spacing are relatively long affording them more opportunity to bend or reshape under the weight of a hailstone. Accordingly, when a hailstone falls onto a netting of at least some aspects or embodiments of the invention, the netting may absorb most of the kinetic energy or velocity of the falling hailstone upon initial impact (thereby protecting a crop beneath), and then a crossover filament or crossover filaments upon which the hail stone has fallen may bend such that the aperture size of the netting immediately beneath the hailstone increases, and the hailstone may then fall through. This can assist in mitigation of hail accumulation on the upper surface of a netting.

Mitigation of hail accumulation on an upper surface of a netting may be an advantage because the weight of accumulated hail on the upper surface of a netting can be significant, and such weight can result in damage to the netting or to structures that support the netting. Hail often melts very quickly at ground level, or when in contact with ground level objects such as a hail netting, and this also facilitates hail to fall through the netting after initially landing on the net.

An advantage of the above invention, at least in the aspects or embodiments directed to a pillar knitted fabric having a wide pillar spacing in part of the material, is that it provides an option of manufacturing on a single loom a pillar knitted fabric having larger apertures in one or some regions, and smaller apertures in other regions. Such larger apertures may be advantageous to allow passage of bees, or to provide a “drain” for hail that has fallen upon a net. Knitting on a single loom may be advantageous because it avoids the additional work that may otherwise be required to join separately manufactured sections of fabric.

An advantage of the invention, at least in the aspects or embodiments having crossover yarns with differing length crossover sections, may be that increased hail passage through a netting and less hail accumulation on the upper surface thereof may be achieved, compared to prior art.

The embodiments described above may also be said broadly to consist in the parts, elements and features referred to or indicated in the specification of the application, individually or collectively, and any or all combinations of any two or more said parts, elements or features, and where specific integers are mentioned herein which have known equivalents in the art to which the embodiments relates, such known equivalents are deemed to be incorporated herein as of individually set forth.

Where specific integers are mentioned herein which have known equivalents in the art to which this invention relates, such known equivalents are deemed to be incorporated herein as if individually set forth.

Aspects of the crop nettings of the invention have been described by way of example only and it should be appreciated that modifications and additions may be made thereto without departing from the scope of the claims herein.

The following is a description of the spectrophotometer system and measuring method used for measuring solar radiation transmittance and reflectance values across the range 220 to 2500 nm quoted in the specification unless otherwise stated.

In this specification, diffuse transmittance and diffuse reflectance data is measured of filaments or tapes themselves of the netting or ground cover material. For filaments, filaments are aligned side by side with no (or minimal) gaps between them to create a surface area large enough for a monochromatic beam to focus upon. The method of measurement is described below. Diffuse reflectance and diffuse transmittance of a region of netting or ground cover material as a whole can be calculated by determining the proportion of area covered by the tapes or filaments versus that not covered by tapes or filaments.

The spectrophotometer system is based around a GSA/McPherson 2051 1 metre focal length monochromator fitted with a prism predisperser and also stray light filters. The light source is a current regulated tungsten halogen lamp. The bandwidth is adjustable up to 3 nm. The monochromatic beam from the monochromator is focused onto the sample or into the integrating sphere using off-axis parabolic mirrors. The integrating spheres are coated with pressed halon powder (PTFE powder). Halon powder is also used as a white reflectance reference material. The detector is usually a silicon photodiode connected to an electrometer amplifier and digital volt meter. The whole system is controlled using software written in LabVIEW. The detectors used can be photomultiplier tubes, silicon diodes or lead sulphide detectors.

Diffuse reflectance is measured using an integrating sphere with an internal diameter of 75 mm with the sample tilted at an angle of 6° to the incident light (specular reflectance included). The reference sample is pressed halon powder and a black cone is used to correct for stray light. Up to four test samples are mounted on a pneumatic driven sample changer along with the white reference and black cone.

Diffuse transmittance is measured using an integrating sphere with an internal diameter of 120 mm and coated with pressed halon powder. The sample is mounted on one port and the incident light port is at an angle of 90° around the sphere. The sphere rotates by 90° in the horizontal plane to allow the focused incident light to enter the sphere through the incident light port or the incident light to be transmitted through the sample and enter the sphere. The detector is mounted at the top of the sphere.

Absorbance is calculated as a back calculation from the calculated transmittance and reflectance values.

The foregoing describes the invention including preferred forms thereof. Alterations and modifications as will be obvious to those skilled in the art are intended to be incorporated in the scope hereof, as defined in the accompanying claims. The skilled reader will understand that some embodiments of the invention may be achieved with knit or weave patterns other than those explicitly disclosed herein.

1. A crop netting comprising:
parallel spaced knitted or twisted yarn pillars, and
crossover yarns comprising crossover yarn sections extending between adjacent ones of the spaced knitted or twisted yarn pillars,
wherein adjacent ones of the spaced knitted or twisted yarn pillars are spaced apart by about 14 mm and about 30 mm, and
wherein apertures defined between adjacent ones of the crossover yarn sections have a maximum dimension parallel to the spaced knitted or twisted yarn pillars between about 1 mm and about 8 mm.

2. The crop netting of claim 1 wherein adjacent ones of the spaced knitted or twisted yarn pillars are spaced by between about 16 mm and about 28 mm.

3. The crop netting of claim 1 wherein adjacent ones of the spaced knitted or twisted yarn pillars are spaced by between about 18 mm and about 26 mm.

4. The crop netting of claim 1 wherein adjacent ones of the spaced knitted or twisted yarn pillars are spaced by between about 18 mm and about 22 mm.

5. The crop netting of claim 1 wherein adjacent ones of the spaced knitted or twisted yarn pillars are spaced by between about 20 mm and about 26 mm.

6. The crop netting of claim 1 wherein adjacent ones of the spaced knitted or twisted yarn pillars are spaced by between about 22 mm and about 26 mm.

7. The crop netting of claim 1 wherein the apertures defined between adjacent ones of the crossover yarn sections have a maximum dimension parallel to the spaced knitted or twisted yarn pillars between about 1 mm and about 6 mm.

8. The crop netting of claim 3 wherein the apertures defined between adjacent ones of the crossover yarn sections have a maximum dimension parallel to the spaced knitted or twisted yarn pillars between about 1 mm and about 6 mm.

9. The crop netting of claim 4 wherein the apertures defined between adjacent ones of the crossover yarn sections have a maximum dimension parallel to the spaced knitted or twisted yarn pillars between about 1 mm and about 6 mm.

10. The crop netting of claim 5 wherein the apertures defined between adjacent ones of the crossover yarn sections have a maximum dimension parallel to the spaced knitted or twisted yarn pillars between about 1 mm and about 6 mm.

11. The crop netting of claim 6 wherein the apertures defined between adjacent ones of the crossover yarn sections have a maximum dimension parallel to the spaced knitted or twisted yarn pillars between about 1 mm and about 6 mm.

12. The crop netting of claim 1 wherein adjacent ones of the spaced knitted or twisted yarn pillars are knitted yarn pillars.

13. The crop netting of claim 12 wherein the crop netting is a knitted netting.

14. The crop netting of claim 12 wherein the apertures defined between adjacent ones of the crossover yarn sections are generally triangular apertures.

15. The crop netting of claim 1 wherein the crop netting is a woven netting.

16. The crop netting of claim 15 wherein the adjacent ones of the spaced knitted or twisted yarn pillars are twisted yarn pillars.

17. The crop netting of claim 15 wherein the apertures defined between adjacent ones of the crossover yarn sections are generally rectangular or generally square apertures.

18. The crop netting of claim 1 wherein when the netting is held taut in a direction across the spaced pillars, a midpoint of longer ones of the crossover yarn sections can be moved in a direction parallel to the spaced pillars by at least 4 mm.

19. The crop netting of claim 1 wherein when the netting is held taut in a direction across the spaced knitted pillars, a midpoint of longer ones of the crossover yarn sections can be moved in a direction parallel to the spaced pillars by at least 6 mm.

20. The crop netting of claim 1 wherein when the netting is held taut in a direction across the spaced knitted pillars, a midpoint of longer ones of the crossover yarn sections can be moved in a direction parallel to the spaced pillars by at least 0.18 mm for every 1 mm of length of the longer ones of the crossover yarn sections.

21. The crop netting of claim 1 wherein the spaced knitted or twisted yarn pillars and the crossover yarn sections are present in a first region of a netting material which is a main body region which comprises more than about 50% of the crop netting.

22. The crop netting of claim 21 wherein the first region comprises a band or bands extending along the spaced knitted or twisted yarn pillars.
